(19) United States
(12) Patent Application Publication
(10) Pub. No.: US 2020/0258105 A1
(43) Pub. Date: Aug. 13, 2020

(54) MUTUALLY REPULSING CENTROIDS FOR SEGMENTING A VAST SOCIAL GRAPH

(71) Applicant: AFFINIO INC., Halifax, NS (CA)

(72) Inventor: Stephen James Frederic Hankinson, Hammonds Plains, Nova Scotia (CA)

(21) Appl. No.: 16/755,276

(22) PCT Filed: Nov. 1, 2018
(86) PCT No.: PCT/IB2018/058585

§ 371 Date: Apr. 10, 2020

Related U.S. Application Data
(60) Provisional application No. 62/580,388, filed on Nov. 1, 2017.

(51) Int. Cl. G06Q 30/02; G06Q 10/10; G06Q 50/00; G06F 16/901; G06K 9/62

(52) U.S. Cl. CPC G06Q 30/0204; G06Q 10/10; G06K 9/6272; G06F 16/9024; G06Q 50/01

(57) ABSTRACT

A method of generating a centroid set of mutually repulsing centroids for segmenting a vast social graph is disclosed. Each object of a collection of tracked objects of the social graph is characterized by a respective descriptor vector of multiple descriptor types. Starting with an empty centroid set, an object joins the centroid set as a centroid upon ascertaining that an affinity measure of the object to each centroid of the centroid set is less than a specified affinity threshold. The affinity threshold may be tuned to generate a target number of centroids. The affinity measure may be a dual radial-angular affinity measure. Rather than selecting the centroids from the collection of objects, a distribution function of descriptors of each descriptor type may be determined, candidate descriptor vectors may be generated by random sampling of each distribution, and a candidate descriptor vector joins the centroid set upon satisfying affinity conditions.

### CROSS-REFERENCE TO RELATED APPLICATIONS

The present application claims the benefit from U.S. provisional application 62/580,388 filed on Nov. 1, 2017, entitled “Mutually repulsing centroids for segmenting a vast social graph”, the entire content of which is incorporated herein by reference.

### FIELD OF THE INVENTION

The present invention relates to clustering of a large number of objects. In particular, the invention is directed to selection of centroid seeds for efficient segmentation of a social graph representing a large number of tracked users of social networks.

### BACKGROUND

Finding a global optimal segmentation of a population of a large number of objects, exceeding 10000 for example, may require prohibitively extensive computational effort. Using the K-means method with a predefined objective function, an attained segmentation of a population under consideration into K clusters, K being a specified integer exceeding unity, corresponds to a local minimum of the objective function.

For a particular population of objects, and for: a given number of clusters; a particular affinity-measure definition; and a particular rule for assigning an object to a cluster; the contents of the steady-state clusters are not unique. The segmentation rule attempts to maximize a metric of overall object-centroid affinity. However, a person skilled in the art is well aware that, for a large number of objects, a global maximum metric is generally not attainable, except by lucky coincidence. The contents of the clusters are heavily dependent on the initial selection of the set of clusters and, to a lesser extent, on the sequential order in which the objects—or candidate descriptor vectors in general—are considered. Additionally, the segmentation computational effort strongly depends on the initial selection of the set of clusters.

### SUMMARY

The objective of the invention is to provide methods of segmenting objects of a vast social graph into clusters of objects for enhancing marketing intelligence. An initial set of clusters each populated with a single centroid is used to start the segmentation process. The segmentation process assigns objects to clusters according to affinity measures of each object to centroids of the clusters and rules based on the affinity measures. The objects, and consequently the centroids, are represented as descriptor vectors in a multi-dimensional descriptor space. The addition of an object to a cluster naturally changes the position of the centroid of the cluster in the multi-dimensional descriptor space. Consequently, the segmentation process has to be repeated numerous times to redefine the centroids until steady-state descriptor vectors of the centroids are reached.

A judicial selection of the initial centroid set can result in creating clusters of improved distinctive contents as well as reducing the segmentation computational effort. The judicial selection according to the present invention is based on finding mutually repulsing centroids based on predefined affinity thresholds.

The methods of present invention, together with the methods disclosed in U.S. Provisional Application 62/558,085 (filed on Sep. 12, 2017, entitled “Composite Radial-Angular Clustering of a Large-Scale Social Graph”) aim at minimizing a first metric of global inter-centroid affinity and subsequently maximizing a second metric of global object-centroid affinity.

In accordance with an aspect, the invention provides a method of generating a set of centroids of a plurality of objects. The method comprises processes of specifying a target number of centroids and employing a processor to execute instructions for: obtaining, for each object of the plurality of objects, a respective characterizing vector of v variables, v>1; determining for each variable of the v variables respective moments based on obtained characterizing vectors; repeating a procedure of generating a centroid until the target number of centroids is attained, and storing the set of centroids for starting a segmentation process of the plurality of objects.

The procedure for generating a centroid comprises processes of generating v random cumulative-probability values and for each variable, accessing a respective software module providing a deduced value of the variable corresponding to a respective one of the random cumulative-probability values, the deduced value being an element of a vector representing a new centroid of the set of centroids, the respective software module being configured to evaluate a respective probability distribution function tailored to the respective moments.

The process of obtaining, for each object of the plurality of objects, a respective characterizing vector of v variable further comprises processes of: assigning v weights to the v variables, each weight being variable specific and bounded to positive values not exceeding 1.0;

and normalizing each of the v variables so that: a minimum value of each variable equals 0.0; and a maximum value of each variable equals a corresponding variable-specific weight.

The method further comprises selecting the respective probability distribution function as one of: a Gamma distribution; a Weibull distribution; and a piecewise linear distribution. The respective moments comprise at least a first moment and a second moment. The type of the respective probability distribution function may be user defined.

In accordance with another aspect, the invention provides a method of generating centroids of a plurality of objects. The method comprises specifying an affinity threshold and employing a processor to execute instructions for: acquiring a descriptor vector of v variables, v>1, for each object of the plurality of objects; initializing a centroid set to include an object of the plurality of objects; and performing for each object of the plurality of objects a procedure for deciding whether the object qualifies as a centroid. The procedure comprises determining an affinity measure to each centroid of the centroid set based on a descriptor vector of the each object and a descriptor vector of the each centroid and selecting the each object as a centroid to be added to the centroid set subject to ascertaining that the affinity measure to the each centroid is less than the affinity threshold. Thereby, the method creates a set of uniformly spaced centroids for use in automated intelligent-marketing systems.

The process of acquiring a descriptor vector comprises normalizing the v variables so that a value of each variable is within a predefined range.

In one implementation, normalizing the v variables comprises scaling the variables so that a mean value of each variable equals 1.0. In another implementation, normalizing the v variables comprises shifting and scaling the variables so that a minimum value and a maximum value of each variable equal 0.0 and 1.0 respectively. In a further implementation, normalizing the v variables comprises shifting and scaling the variables so that a minimum value of each variable equals 0.0 and a maximum value of each variable equals a respective variable-specific positive upper bound not exceeding 1.0.

Performing the procedure for determining whether the object qualifies as a centroid is terminated subject to ascertaining that the set of centroids contains a number of centroids equal to a predefined upper bound.

The method further comprises generating non-repeating randomly sequenced indices of objects of the plurality of objects; and selecting objects of the plurality of objects at indices corresponding to the randomly sequenced indices.

The process of determining an affinity measure comprises computing a radial affinity level and an angular-affinity level between each object and each centroid, and computing the affinity measure as a function of the radial-affinity level and the angular-affinity level. The function may be selected as a weighted sum of the radial-affinity level and the angular-affinity level.

In one embodiment, the process of ascertaining that the affinity measure to each centroid is less than the affinity threshold comprises verifying that: the radial-affinity level is less than the radial-affinity threshold; and the angular-affinity level is less than the angular-affinity threshold.

In accordance with a further aspect, the invention provides a method of creating centroids of a plurality of objects. The method comprises specifying an affinity threshold and employing a processor to execute instructions for acquiring, for each object of the plurality of objects, a respective characterizing vector of v variables, v>1, and deducing for each variable a respective cumulative distribution function to produce v cumulative distribution functions. The instructions further cause the processor to execute processes of initializing a centroid set as an empty set, generating a succession of descriptor vectors each comprising v variables, and performing for each descriptor vector of the succession of descriptor vectors a procedure for descriptor-vector election as a centroid vector.

The procedure comprises processes of determining an affinity measure to each centroid of the centroid set based on the each descriptor vector and a descriptor vector of each centroid, and assigning the each descriptor vector to the centroid set as a centroid subject to ascertaining that the affinity measure to the each centroid is less than the affinity threshold.

Thus, the method creates a set of uniformly spaced centroids for use in automated intelligent-marketing systems.

The process of generating a succession of descriptor vectors comprises randomly indexing an inverse of a cumulative distribution function of each variable of the v variables to determine v variable values forming a descriptor vector of the succession of descriptor vectors.

In one implementation, the process of acquiring the respective characterizing vector of v variables comprises normalizing each of the v variables to be within a predefined range.

In another implementation, the process of acquiring the respective characterizing vector of v variables comprises assigning for each variable a respective variable-specific weight greater than 0.0 and not exceeding 1.0, then shifting and scaling each of the variables so that: a minimum value of each variable equals 0.0; and a maximum value of each variable equals a corresponding variable-specific weight.

The affinity measure to the empty centroid set is assigned a value of zero.

The method terminates performing the procedure for descriptor vector election as a centroid vector upon determining that a count of centroids of the set of centroids equals a predefined upper bound.

The process of determining an affinity measure comprises computing a radial affinity level and an angular-affinity level between each descriptor vector and each centroid, and computing the affinity measure as a function of the radial-affinity level and the angular-affinity level. The function may be formed as a weighted sum of the radial-affinity level and the angular-affinity level.

In one implementation, the process of specifying an affinity threshold comprises itemizing the affinity threshold as a radial-affinity threshold and an angular-affinity threshold. Accordingly, the process of determining an affinity measure comprises computing a radial affinity level and an angular-affinity level between the each descriptor vector and each centroid. Subsequently, ascertaining that the affinity measure to each centroid is less than the affinity threshold comprises verifying that the radial-affinity level is less than the radial-affinity threshold and the angular-affinity level is less than the angular-affinity threshold.

In accordance with a further aspect, the invention provides a method of creating centroids of a plurality of objects. The method comprises specifying a target number of centroids and an affinity threshold, and defining bounds of v variables, v>1, each object of the plurality of objects being characterized by a respective vector of descriptors of the v variables within the bounds. A processor is employed to execute instructions for generating a maximal centroid set comprising a maximum attainable number of centroids selected from the plurality of objects conditional on an affinity measure of each centroid to each other centroid being less than the affinity threshold. Where the maximum attainable number differs from the target number, the instructions further cause the processor to execute processes of iteratively tuning the affinity threshold and generating the centroid set until the maximum attainable number equals the target number or a predefined permissible number of iterations is reached. The maximal centroid set is stored for starting a segmentation process of the plurality of objects.

Tuning the affinity threshold comprises increasing the affinity threshold subject to a determination that the maximum attainable number is less than the target number, or decreasing the affinity threshold subject to a determination that the maximum attainable number exceeds the target number.

Generating a centroid set comprises initializing the centroid set as an empty set of zero count of centroids and performing for each object processes of: determining an affinity measure to each centroid of the centroid set; and adding the each object to the centroid set, updating the count of centroids, subject to ascertaining that the affinity measure to each centroid is less than the affinity threshold. When all objects are considered, the count of centroids becomes the maximum attainable number of centroids. In one implementation, the affinity measure is determined as a composite radial-angular affinity measure formulated as a function of a radial-affinity level and an angular affinity level and the affinity threshold is determined as a specific value of the composite radial-angular affinity measure.

Alternatively, generating the centroid set comprises initializing the centroid set as an empty set of zero count of centroids and performing for each object processes of: determining a radial affinity level and an angular affinity level to each centroid of the centroid set; and adding the each object to the centroid set, updating the count of centroids, subject to ascertaining that the radial affinity level to the each centroid is less than a predefined radial threshold and the angular affinity level to the each centroid is less than the angular threshold. When all objects are considered, the count of centroids becomes the maximum attainable number of centroids.

In accordance with a further aspect, the invention provides a method of creating centroids of a plurality of objects. The method comprises specifying a target number of centroids, a radial threshold, and an angular threshold, and defining bounds of v variables, v>1, each object of the plurality of objects being characterized by a respective vector of descriptors of the v variables within the bounds. A processor is employed to execute instructions for generating a maximal centroid set comprising a maximum attainable number of centroids selected from the plurality of objects conditional on a radial affinity level of each centroid to each other centroid being less than the radial threshold and an angular affinity level of each centroid to each other centroid being less than the angular threshold. Upon determining that the maximum attainable number of centroids differs from the target number, the instructions cause the processor to execute processes of iteratively tuning the radial threshold and the angular threshold, and generating the centroid set until the maximum attainable number equals the target number or a predefined permissible number of iterations is reached. The generated maximal centroid set is stored for use in a segmentation process of the plurality of objects.

Tuning the radial threshold and the angular threshold comprises increasing at least one of the radial and the angular thresholds subject to a determination that the maximum attainable number is less than the target number, or decreasing at least one of the radial and the angular thresholds subject to a determination that the maximum attainable number exceeds the target number.

Generating the centroid set comprises initializing a centroid set as an empty set of zero count of centroids and performing for each object processes of: determining a radial affinity level and an angular affinity level to each centroid of the centroid set; and adding the each object to the centroid set and updating the count of centroids subject to ascertaining that the radial affinity level to each centroid is less than the radial threshold and the angular affinity level to each centroid is less than the angular threshold. When all objects are considered, the count of centroids becomes the maximum attainable number of centroids.

The method further comprises determining the radial threshold as a mean value of a radial lower bound and a radial upper bound, and determining the angular threshold as a mean value of an angular lower bound and an angular upper bound.

In accordance with a further aspect, the invention provides an apparatus for generating a set of centroids of a plurality of objects. The apparatus comprises a memory device storing processor executable instructions causing a processor to determine a target number of centroids; obtain, for each object of the plurality of objects, a respective characterizing vector of v variables, v>1; and determine for each variable of the v variables respective moments based on obtained characterizing vectors. The instructions cause the processor to generate v random cumulative-probability values and, for each variable, access a respective software module providing a deduced value of each variable corresponding to a respective one of the random cumulative-probability values, the deduced value being an element of a vector representing a new centroid of the set of centroids, the respective software module being configured to evaluate a respective probability distribution function tailored to the respective moments. The instructions cause the processor to repeat generating a new centroid until the target number of centroids is attained. The set of centroids is stored in a storage medium for starting a segmentation process of the plurality of objects.

In accordance with a further aspect, the invention provides an apparatus for generating centroids of a plurality of objects. The apparatus comprises a memory device storing processor executable instructions causing a processor to determine an affinity threshold, acquire a descriptor vector of v variables, v>1, for each object of the plurality of objects, and initialize a centroid set to include an object of the plurality of objects. The instructions cause the processor to determine, for each object of the plurality of objects, an affinity measure to each centroid of the centroid set as a function of a descriptor vector of the each object and a descriptor vector of each centroid. An object is added as a centroid to the centroid set subject to ascertaining that the affinity measure to each centroid is less than the affinity threshold. Thus, the apparatus creates a set of uniformly spaced centroids for use in automated intelligent-marketing systems.

In accordance with a further aspect, the invention provides an apparatus for creating centroids of a plurality of objects. The apparatus comprises a memory device storing processor executable instructions causing a processor to obtain an affinity threshold, acquire, for each object of the plurality of objects, a respective characterizing vector of v variables, v>1, and deduce for each variable a respective cumulative distribution function to produce v cumulative distribution functions.

The instructions further cause the processor to initialize a centroid set as an empty set, generate a succession of descriptor vectors each comprising v variables, and determine, for each descriptor vector of the succession of descriptor vectors, an affinity measure to each centroid of the centroid set as a function of the each descriptor vector and a descriptor vector of each centroid. A descriptor vector is assigned to the centroid set as a centroid subject to ascertaining that the affinity measure to each centroid is less than the affinity threshold. Thus, the apparatus creates a set of uniformly spaced centroids for use in automated intelligent-marketing systems.

In accordance with a further aspect, the invention provides an apparatus for creating centroids of a plurality of objects. The apparatus comprises a memory device storing processor executable instructions causing a processor to: obtain from a user a target number of centroids and an affinity threshold; acquire bounds of v variables, v>1, each object of the plurality of objects being characterized by a respective vector of descriptors of the v variables within the bounds; and generate a centroid set comprising a maximum attainable number of centroids selected from the plurality of objects conditional on an affinity measure of each centroid to each other centroid being less than the affinity threshold.

Where the maximum attainable number differs from the target number, the instructions cause the processor to iteratively tune the affinity threshold, and generate a corresponding centroid set until the maximum attainable number equals the target number or a predefined permissible number of iterations is reached.

The maximal centroid set is stored for starting a segmentation process of the plurality of objects.

In accordance with a further aspect, the invention provides an apparatus for creating centroids of a plurality of objects. The apparatus comprises a memory device storing processor executable instructions causing a processor to: obtain from a user a target number of centroids, a radial threshold, and an angular threshold; acquire bounds of v variables, v>1, each object of the plurality of objects being characterized by a respective vector of descriptors of the v variables within the bounds; and generate a maximal centroid set comprising a maximum attainable number of centroids selected from the plurality of objects conditional on a radial affinity level of each centroid to each other centroid being less than the radial threshold; and an angular affinity level of each centroid to each other centroid being less than the angular threshold.

Where the maximum attainable number differs from the target number, the instructions cause the processor to iteratively tune the radial threshold and the angular threshold, and generate a corresponding centroid set until the maximum attainable number equals the target number or a predefined permissible number of iterations is reached.

The maximal centroid set is stored for starting a segmentation process of the plurality of objects.

To generate a maximal centroid set, the instructions cause the processor to: initialize a centroid set as an empty set of zero count of centroids, and for each object: determine a radial affinity level and an angular affinity level to each centroid of the centroid set; and add the each object to the centroid set and update the count of centroids subject to a determination that the radial affinity level to each centroid is less than the radial threshold and the angular affinity level to each centroid is less than the angular threshold.

When all objects are considered, the count of centroids becomes the maximum attainable number of centroids.

### BRIEF DESCRIPTION OF THE DRAWINGS

Embodiments of the present invention will be further described with reference to the accompanying exemplary drawings, in which:

FIG. 1 illustrates a population of tracked objects and a plurality of centroid seeds to be determined according to mutual affinity constraints for use in forming clusters of objects in accordance with an embodiment of the present invention;

FIG. 2 illustrates boundaries of descriptors of the population of tracked objects;

FIG. 3 illustrates descriptor vectors of a population of tracked objects in accordance with an embodiment of the present invention;

FIG. 4 illustrates a first-mode normalization of the descriptors in accordance with an embodiment of the present invention;

FIG. 5 illustrates a second-mode normalization of the descriptors in accordance with an embodiment of the present invention;

FIG. 6 illustrates determining parameters of a deduced probability function of each descriptor based on moments of corresponding tracked data;

FIG. 7 illustrates generation of candidate centroids based on a cumulative distribution function of each variable (each descriptor) derived according to moments of respective descriptor data where all variables (all descriptor values) are normalized according to the first mode;

FIG. 8 illustrates generation of candidate centroids based on a cumulative distribution function of each descriptor derived according to moments of respective descriptor data where all variables (all descriptor values) are normalized according to the second mode;

FIG. 9 illustrates generation of candidate centroids based on a complementary function of each descriptor derived according to moments of respective descriptor data where all variables (all descriptor values) are normalized according to the second mode;

FIG. 10 illustrates generation of candidate centroids based on cumulative distribution of each descriptor of the population of tracked objects where all variables (all descriptor values) are normalized according to the first mode;

FIG. 11 illustrates generation of candidate centroids based on cumulative distribution of each descriptor of the population of tracked objects where all variables (all descriptor values) are normalized according to the second mode;

FIG. 12 illustrates options of determining centroids based on different affinity constraints for different descriptor normalization modes and different descriptor-vector selection methods, in accordance with an embodiment of the present invention;

FIG. 13 illustrates generation of candidate centroid vectors based on a cumulative distribution function of each descriptor derived according to moments of respective descriptor data;

FIG. 14 illustrates a criterion for selecting centroids based on inter-centroid affinity constraints, in accordance with an embodiment of the present invention;

FIG. 15 illustrates selection of a new centroid based on both radial and angular affinity of a candidate centroid with respect to present centroids, in accordance with an embodiment of the present invention;

FIG. 16 illustrates a method of determining the maximum attainable number of centroids based on a specified single (radial, angular, or a composite radial-angular) affinity constraint and random object selection, in accordance with an embodiment of the present invention;

FIG. 17 illustrates a method of determining the maximum attainable number of centroids based on a specified single (radial or angular) affinity constraint and the method of selecting a candidate centroid illustrated in FIG. 8 or FIG. 9, in accordance with an embodiment of the present invention;

FIG. 18 illustrates a method of determining the maximum attainable number of centroids based on a specified dual radial-angular affinity constraint and random object selection, in accordance with an embodiment of the present invention;

FIG. 19 illustrates a method of determining the maximum attainable number of centroids based on a specified dual radial-angular affinity constraint and the method of selecting a candidate centroid illustrated in FIG. 8 or FIG. 9, in accordance with an embodiment of the present invention;

FIG. 20 illustrates a method of determining a single (radial, angular, or composite radial-angular) inter-centroid affinity constraint corresponding to a target number of centroids based on the method of determining a maximum attainable number of centroids illustrated in FIG. 16 or FIG. 17, in accordance with an embodiment of the present invention;

FIG. 21 illustrates iterative processes of the method of FIG. 20;

FIG. 22 illustrates a method of determining a dual radial-angular inter-centroid affinity constraint corresponding to a target number of centroids based on the method of determining a maximum attainable number of centroids illustrated in FIG. 18 or FIG. 19, in accordance with an embodiment of the present invention;

FIG. 23 illustrates iterative processes of the method of FIG. 22;

FIG. 24 illustrates a method of determining a single (radial or angular) inter-centroid affinity constraint corresponding to a target number of centroids based on interpolation using attainable numbers of centroids, in accordance with an embodiment of the present invention;

FIG. 25 illustrates a method of determining cumulative distribution functions for a number of variables for use in an embodiment of the present invention;

FIG. 26 illustrates a method of determining a set of centroids from distribution functions of multiple variables characterizing a plurality of objects, in accordance with an embodiment of the present invention;

FIG. 27 illustrates affinity measures based on raw variables and weighted variables;

FIG. 28 illustrates normalized variables where a minimum value of each variable equals 0.0 and a maximum value of each variable equals a corresponding variable-specific weight, in accordance with an embodiment of the present invention;

FIG. 29 illustrates assigning weights to four variables characterizing objects, each weight being variable specific and bounded to positive values not exceeding 1.0, in accordance with an embodiment of the present invention;

FIG. 30 illustrates randomly sampling cumulative distribution functions of a number of variables to generate object descriptor vectors, in accordance with an embodiment of the present invention;

### REFERENCE NUMERALS

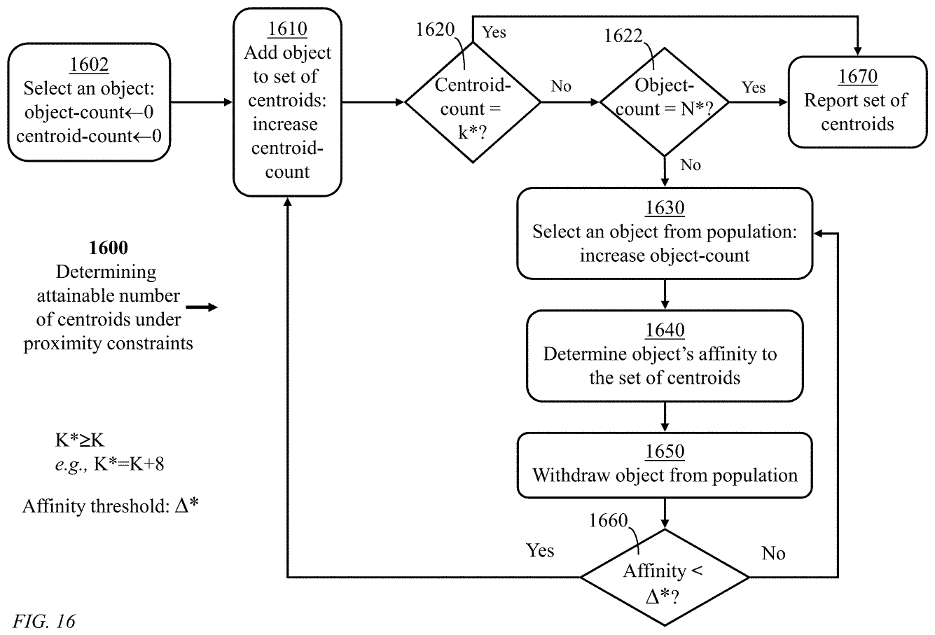

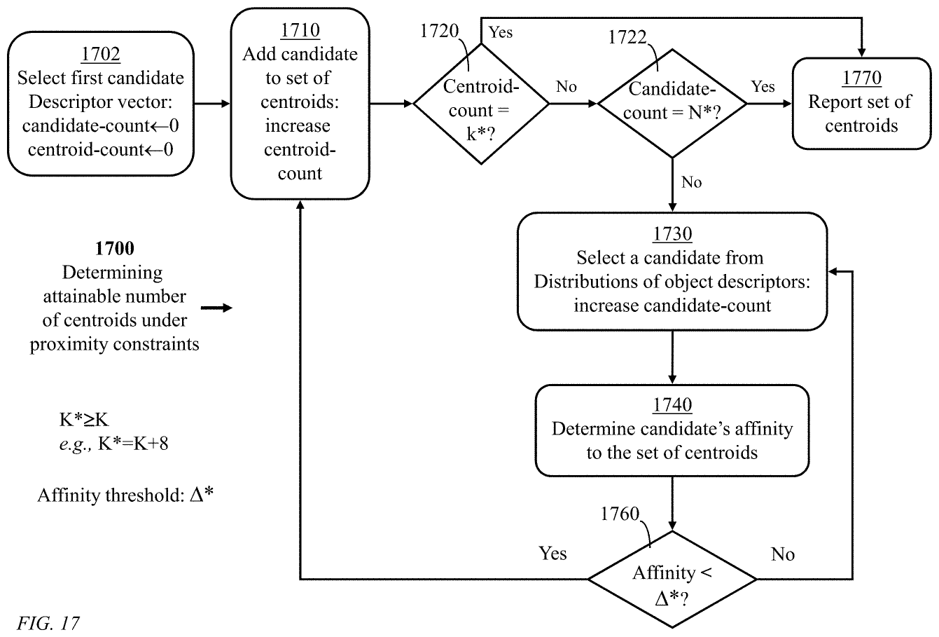

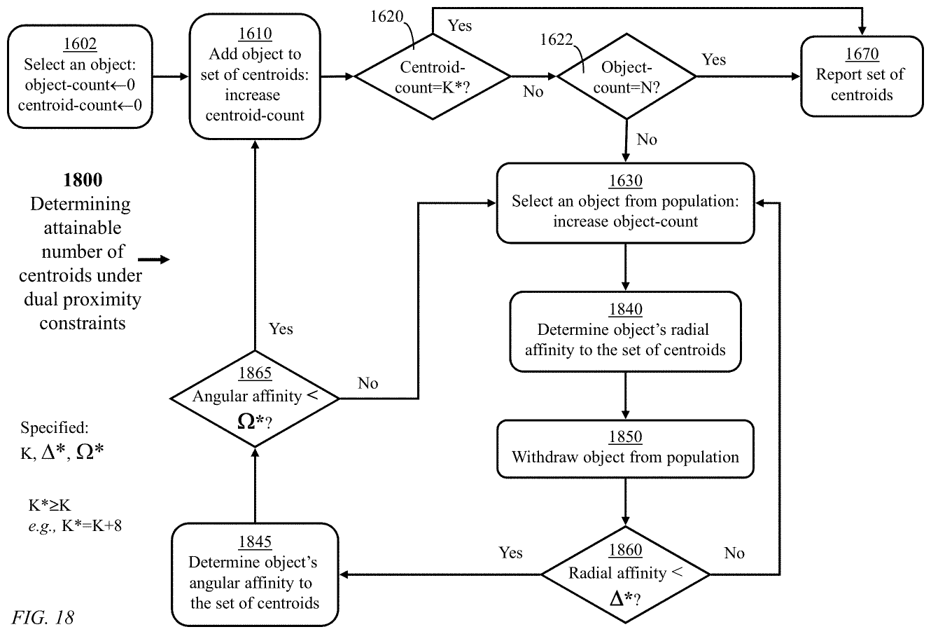

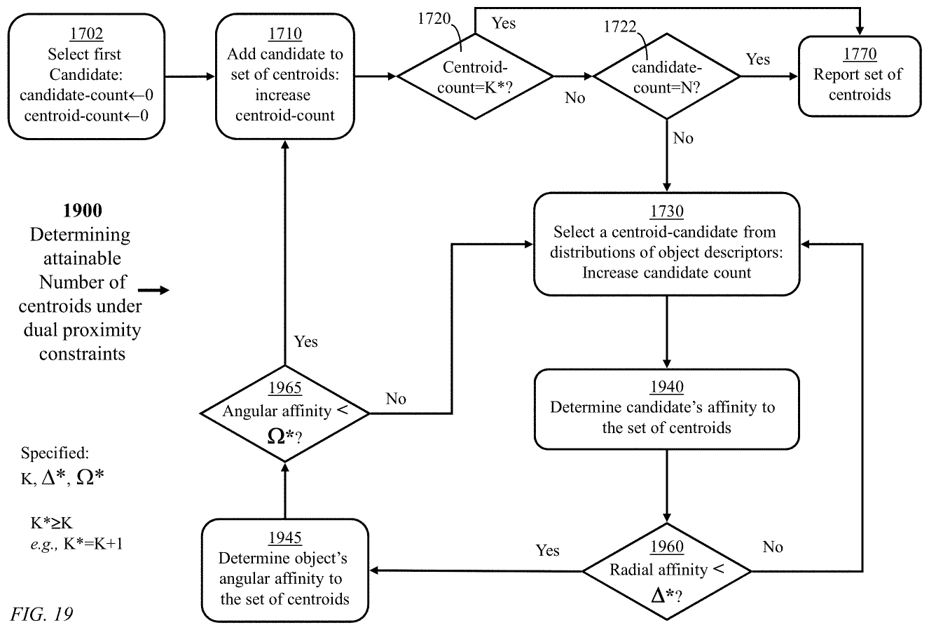

100: Visualization of tracked objects and centroid seeds of clusters of objects
120: Object representation
140: Centroid representation
200: Boundaries of variables (descriptors of different descriptor types)
210: Lower bound of a descriptor (210(p), 1≤p≤v)
220: Upper bound of a descriptor (220(p), 1≤p≤v)
230: First intermediate bound of a descriptor
240: Second intermediate bound of a descriptor
300: Characterization of tracked objects
302: Descriptor index “p” (1≤p≤v)
304: Object index “q” (0≤q<N)
305: Collection of tracked objects
306: Value of a descriptor
308: Mean value μₚ of a descriptor p, 1≤p≤v
310: Standard deviation Σₚ of a descriptor 1≤p≤v
312: Standard deviation σₚ of a normalized descriptor (σₚ=Σₚ<μₚ)
400: Descriptor normalization—first mode
500: Descriptor normalization—second mode
600: Generation of parameters of deduced descriptor probability functions
610: Object-characterization parameters
612: Mean value μₚ of a descriptor (1≤p≤v)
614: Standard deviation σₚ of a normalized descriptor (0≤p<v)
618: Bounds of a descriptor (210, 220)
620: Deduced probability function
630: Software module implementing a probability function (cumulative or complementary functions)
640: Parameters defining a deduced probability function
641: A first parameter of a deduced probability function
642: A second parameter of a deduced probability function
700: Generation of candidate centroids based on deduced descriptor cumulative distribution functions with variables (descriptor values) normalized according to the first mode
720: Deduced descriptor cumulative distribution function (720(p), 1≤p≤v)
722: Indices of cumulative distribution functions 820
724: Descriptor index
800: Generation of candidate centroids based on deduced descriptor cumulative distribution functions with variables (descriptor values) normalized according to the second mode
820: Deduced descriptor cumulative distribution function (820(p), 1≤p≤v)
822: Indices of complementary functions 820
824: Descriptor index
900: Generation of candidate centroids based on deduced descriptor complementary functions with variables (descriptor values) normalized according to the second mode
920: Deduced descriptor complementary function (920(p), 01≤p≤v)
922: Indices of complementary functions 920
1000: Selection of candidate centroids from descriptors of tracked objects with first-mode descriptor normalization
1010: Array of samples of a descriptor (1010(p), 1≤p≤v)
1012: Indices of arrays 1010
1100: Selection of candidate centroids from descriptors of tracked objects with second-mode descriptor normalization
1110: Array of samples of a descriptor (1110(p), 1≤p≤v)
1112: Indices of arrays 1110
1200: Options of centroid-seed selections
1300: Generation of candidate-centroid vectors based on descriptors cumulative distributions
1310: Process of generating W samples of each variable, W>>1
1320: Process of generating v random indices (0 o W-1), vbeing the number of descriptors
1330: Process of determining v descriptors
1340: Process of forming a candidate-centroid vector (of dimension v)
1400: Illustration of affinity-constrained centroid seeds
1402: An object of a population of objects
1420: A single-cluster hypersphere
1500: Example of centroid-seed selection under dual radial and angular affinity constraint
1510: An already selected centroid
1520: A candidate centroid
1600: Method of determining an attainable number of centroids under a single (radial or angular) affinity constraint based on descriptors of tracked objects
1602: Initialization process—empty set of centroids and a randomly-selected object as a candidate centroid
1610: Process of adding randomly-selected object to a set of centroids
1620: Process of determining whether an upper bound of the number of centroids has been reached
1622: Process of determining whether all tracked objects have been considered for a potential centroid
1630: A process of (randomly) selecting an object from the population of tracked objects
1640: Process of determining object's affinity to each selected centroid
1650: Process of withdrawing object (whether selected or not) from the population of objects
1660: Process of determining whether the object's affinity to each selected centroid exceeds a predefined constraint
1670: Process of communicating the centroid set to another software module.
1700: Method of determining an attainable number of centroids under a single (radial or angular) affinity constraint based on deduced distributions
1702: Initialization process—empty set of centroids and a randomly generated centroid candidate
1710: Process of adding randomly generated centroid candidate to a set of centroids
1722: Process of determining whether a sufficient number of candidate centroids have been generated
1730: A process of generating candidate centroids from deduced probability functions
1740: Process of determining affinity of candidate centroid to each selected centroid
1760: Process of determining whether the affinity of the candidate centroid to each selected centroid exceeds a predefined constraint
1800: Method of determining an attainable number of centroids under a dual (radial and angular) affinity constraint based on descriptors of tracked objects
1840: Process of determining object's radial affinity to each selected centroid
1845: Process of determining object's angular affinity to each selected centroid
1860: Process of determining whether the object's radial affinity to each selected centroid exceeds a predefined radial-affinity constraint
1865: Process of determining whether the object's angular affinity to each selected centroid exceeds a predefined angular-affinity constraint
1900: Method of determining an attainable number of centroids under a dual (radial and angular) affinity constraint based on deduced distributions
1940: Process of determining radial affinity of candidate centroid to each selected centroid
1945: Process of determining angular affinity of candidate centroid to each selected centroid
1960: Process of determining whether the radial affinity of the candidate centroid to each selected centroid exceeds a predefined constraint
1965: Process of determining whether the angular affinity of the candidate centroid to each selected centroid exceeds a predefined constraint
2000: Method of determining a single (radial or angular) inter-centroid affinity constraint corresponding to a target number of centroids
2010: Process of initializing a lower bound and an upper bound of inter-centroid affinity constraints and initializing a bisection counter
2020: A process of determining a candidate value of inter-centroid single affinity constraint
2022: Process of limiting the number of iterative bisection-search processes
2024: Process of counting bisection-searches
2030: Process (FIG. 16 or FIG. 17) of determining a number of attainable centroids corresponding to a given inter-centroid single affinity constraint (radial or angular)
2040: Process of performing a first comparison of the number of attainable centroids to a target number of centroids
2050: Process of increasing a lower bound of inter-centroid affinity constraint
2060: Process of performing a second comparison of the number of attainable centroids to a target number of centroids
2070: Process of decreasing an upper bound of inter-centroid affinity constraint
2080: Process of storing set of selected centroids.
2110: Candidate value of inter-centroid affinity constraint and resulting number of attainable centroids
2120: Lower bound of inter-centroid affinity constraint
2140: Upper bound of inter-centroid affinity constraint
2200: Method of determining a dual radial-angular inter-centroid affinity constraint corresponding to a target number of centroids
2210: Process of initializing lower bounds and upper bounds of inter-centroid radial and angular affinity constraints and initializing a bisection counter
2220: A process of determining a candidate value of inter-centroid radial affinity constraint
2222: Process of limiting the number of iterative bisection-search processes
2224: Process of counting bisection searches
2225: A process of determining a candidate value of inter-centroid angular affinity constraint
2230: Process (FIG. 18 or FIG. 19) of determining a number of attainable centroids corresponding to a radial affinity constraint and an angular affinity constraint
2235: Process similar to process 2230
2240: Process of determining whether the number of attainable centroids determined in process 2230 is less than a target number of centroids
2245: Process of determining whether the number of attainable centroids determined in process 2235 is less than a target number of centroids
2250: Process of increasing a lower bound of inter-centroid angular affinity constraint
2255: Process of increasing a lower bound of inter-centroid radial affinity constraint
2260: Process of determining whether the number of attainable centroids determined in process 2230 exceeds a target number of centroids
2265: Process of determining whether the number of attainable centroids determined in process 2235 exceeds a target number of centroids
2270: Process of decreasing an upper bound of inter-centroid angular affinity constraint
2275: Process of decreasing an upper bound of inter-centroid radial affinity constraint
2280: Process of storing set of selected centroids.
2310: Candidate values of inter-centroid radial and angular affinity constraints and resulting number of attainable centroids
2320: Lower bound of inter-centroid radial affinity constraint
2330: Lower bound of inter-centroid angular affinity constraint
2340: upper bound of inter-centroid radial affinity constraint
2350: Upper bound of inter-centroid angular affinity constraint
2400: Determination of inter-centroid affinity constraint using interpolation
2410: Inter-centroid affinity threshold
2412: A value of inter-centroid affinity threshold
2420: Attainable number of centroids under inter-centroid affinity constraint
2422: Attainable number of centroids corresponding to 2412
2500: Method of determining cumulative distribution functions of a number of variables
2510: Process of acquiring multivariable descriptors of a plurality of objects
2520: Processes of formulating a cumulative distribution function for each variable
2522: Process of determining at least two moments for each variable
2524: Process of selecting a form of a distribution function for each variable
2526: Process of formulating a cumulative distribution function based on moments determined in process 2522 and a distribution form (model) determined in process 2524
2600: Process of determining a set of centroids from distribution functions of multiple variables
2610: Process of determining a target number of centroids
2620: Processes of generating the target number of centroids
2622: Process of generating a number of random cumulative distribution values (each bounded between 0.0 and 1.0, inclusive)
2624: Process of determining values of variables (representing a new centroid) corresponding to the random cumulative distribution values based on (inverse) cumulative distribution functions of the variables determined in process 2526
2626: Process of forming a new centroid as a vector of the values of variables, and adding the new centroids to a target set of centroids.
2700: comparison between affinity levels based on raw variables and affinity levels based on weighted variables
2710: Descriptor vectors A, B, and C, based on raw values of two variables
2712: Radial affinity levels based on raw values of variables
2720: Descriptor vectors A*, B*, and C*, based on weighted values of one variable
2722: Radial affinity levels based on weighted values of one variable
2800: Cumulative distribution of raw values of variables versus cumulative distributions of weighted values of variables
2820: Values of normalized variables
2821: Cumulative probability P₁ of a first of four raw variables characterizing objects under consideration
2822: Cumulative probability P₂ of a second raw variable
2823: Cumulative probability P₃ of a third raw variable
2824: Cumulative probability P₄ of a fourth raw variable
2860: Values of normalized and weighted variables
2862: Cumulative probability Q₂ of the second variable with a weighting factor ω₂ of 0.8
2863: Cumulative probability Q₃ of the third variable with a weighting factor ω₃ of 0.6
2864: Cumulative probability Q₄ of the fourth variable with a weighting factor ω₂ of 0.4
2900: Normalized versus normalized and weighted variables
2910: Normalized variable
2920: Normalized weighted variable
3000: Process of generating descriptor vectors
3021: Cumulative distribution, first variable
3022: Cumulative distribution, second variable (weighted)
3023: Cumulative distribution, third variable (weighted)
3024: Cumulative distribution, fourth variable (weighted)
3030: A first generated descriptor vector
3032: A first set of random values (r₁, r₂, r₃, r₄) of cumulative probability
3040: A second generated descriptor vector
3042: A second set of random values (r₅, r₆, r₇, r₈) of cumulative probability

### Terminology

Processor: The term processor refers to a single hardware processor or an assembly of hardware processors which may be operated concurrently either independently, according to a pipelined arrangement, or according to other multi-processing arrangements.

Radial-affinity level: The radial affinity level of an object to a centroid (or vice versa) is determined as a function of the Euclidean distance between a descriptor vector characterizing the object and a descriptor vector characterizing the centroid. The radial-affinity level may be normalized so that the affinity level is 1.0 if the Euclidean distance is zero and the affinity level approaches zero as the Euclidean distance increases. Details of computation of a normalized radial-affinity level are provided in Provisional Application 62/558,085, filed on Sep. 12, 2017, entitled “Composite Radial-Angular Clustering OF A Large-Scale Social Graph”.

Angular-affinity level: The angular-affinity level of an object to a centroid (or vice versa) is determined as a function of the dot product of a descriptor vector characterizing the object and a descriptor vector characterizing the centroid. Options of computation of a normalized angular-affinity level are provided in the aforementioned Provisional Application.

Composite radial-angular affinity measure: A composite radial-angular affinity measure of an object to a centroid (or vice versa) is a function (such as a weighted sum) of the radial-affinity level and the angular-affinity level defined above.

Radial-affinity threshold: The term refers to a maximum permissible radial-affinity level of an object to a centroid.

Angular-affinity threshold: The term refers to a maximum permissible angular-affinity level of an object to a centroid.

Radial threshold: A specific value of a radial-affinity measure

Angular threshold: A specific value of an angular-affinity measure

Maximal centroid set: A set of centroids containing the maximum attainable number of centroids selected from a plurality of objects conditional on an affinity measure of each centroid to each other centroid being less than the affinity threshold

Mutually repulsing centroids: With each centroid represented as a multi-dimensional descriptor vector, a centroid set is said to comprise mutually repulsing centroids if the radial-affinity level of each centroid to each other centroid is less than a predefined radial-affinity threshold and/or if the angular-affinity level of each centroid to each other centroid is less than a predefined angular-affinity threshold. The centroids of the centroid set are also considered to be mutually repulsing if the composite radial-angular affinity measure of each centroid pair is less than a predefined composite threshold.

### DETAILED DESCRIPTION

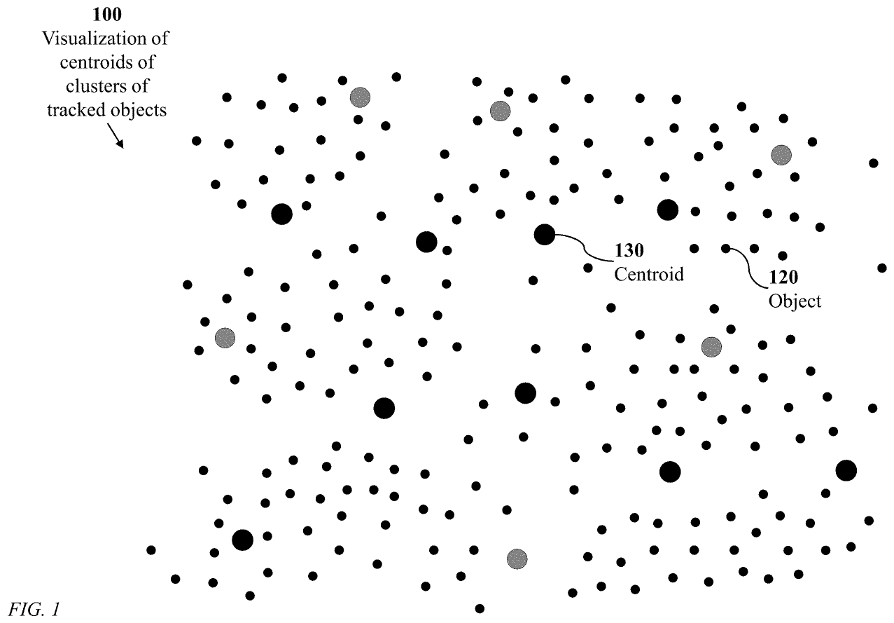

FIG. 1 illustrates a population 100 of tracked objects 120. Each object may be characterized by a number v of descriptors, v>1, forming a respective descriptor vector. A plurality of centroids 140 is determined based on mutual repulsion where the radial distance and/or the angular separation between any centroid seed and each other centroid seed must exceed respective predefined thresholds.

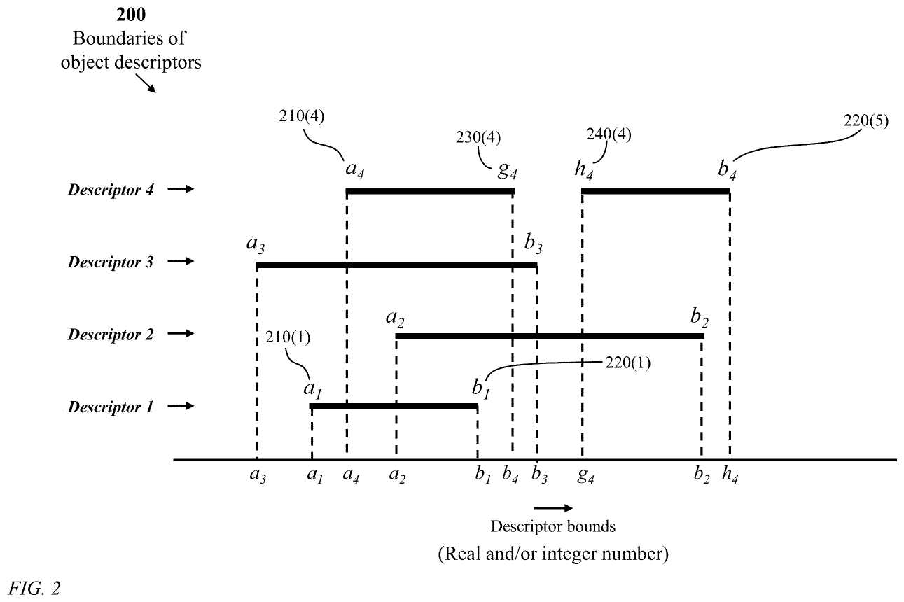

FIG. 2 illustrates boundaries 200 of each of four descriptors. A descriptor 102(p) has a lower bound 210(p), denoted aₚ, and an upper bound 220(p), denoted bₚ, 1≤p≤v. The distribution of a descriptor may be multi-modal. In the example of FIG. 2, each of the descriptors of indices 1, 2, and 3 has a unimodal distribution while the descriptor of index 4 has a bi-modal distribution with values between a₄ and g₄ and values between h₄ to b₄, where a₄<g₄<h₄<b₄. The methods described herein apply uniformly whether the distribution of the values of a descriptor is unimodal or multimodal. The lower bounds and upper bounds may be determined from the distributions of descriptors values.

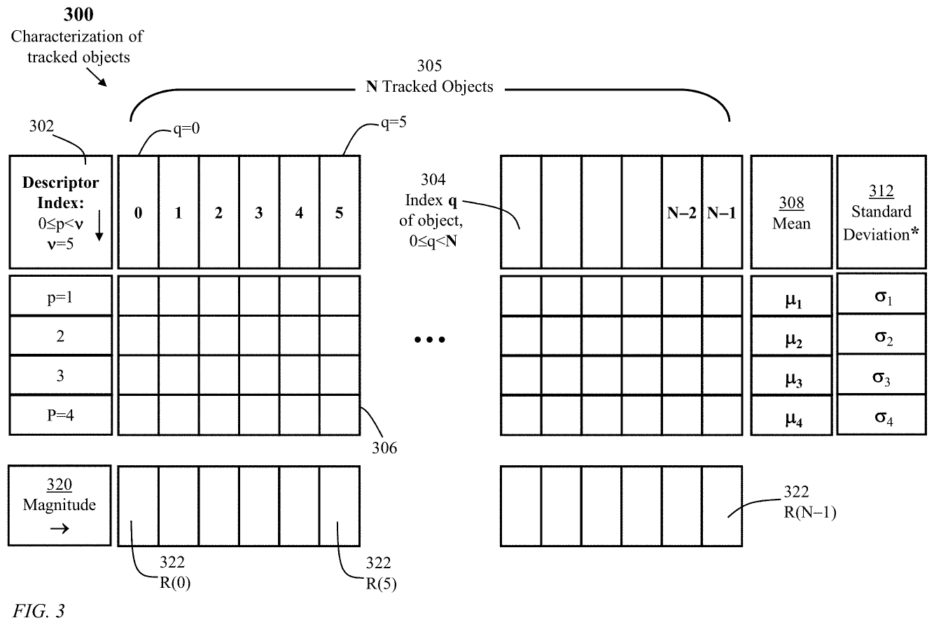

FIG. 3 illustrates data 300 characterizing a plurality 305 of N tracked objects 304, N>>1. Each tracked object 304 is characterized by a descriptor vector of a number v of descriptors 302; v=4 in the illustrated case. The value of a descriptor 302 of index p of an object of index q is denoted Γ(p,q), 1≤p≤v, 0≤q<N. The mean value 308 of a descriptor of index p is denoted μₚ, 1≤p≤v;

μₚ={Γ(p,0)+Γ(p,1)+ . . . +Γ(p, N−1)}/N.

Preferably, the values of the descriptors are normalized; hereinafter, all descriptors are considered to be normalized.

In accordance with a first-mode normalization criterion, the variables (descriptor values) are normalized so that the mean value of each descriptor is 1.0. Thus, the normalized value 306 of a descriptor 302 of index p of an object of index q, denoted γ(p,q), is determined as:

γ(p, q)=Γ(p,q)/μₚ, 0≤p≤v, 0≤q<N.

The standard deviation 312 of the normalized values of a descriptor 302(p) is denoted σₚ, 1≤p≤v.

In accordance with a second-mode normalization criterion, the variables (descriptor values) are normalized so that the minimum value of each descriptor is zero and the maximum value is 1.0. Thus, the normalized value 306 of a descriptor 302 of index p of an object of index q is determined as: γ(p, q)=(Γ(p,q)-aₚ)/(bₚ-aₚ), 1≤p≤v, 0≤q<N, where aₚ and bₚ are the lower bound and upper bound, respectively, of a descriptor of index p.

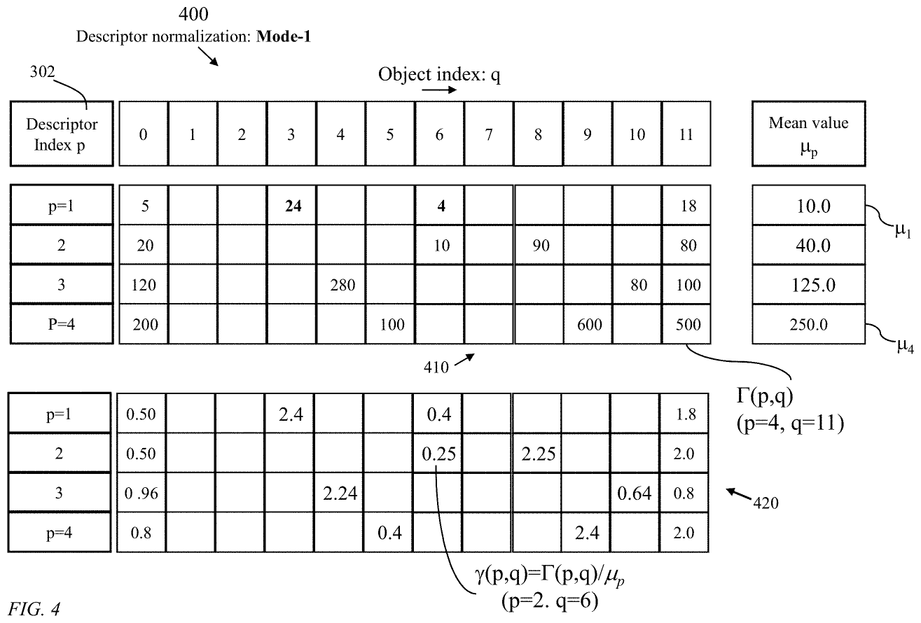

FIG. 4 illustrates first-mode normalization of four descriptors of twelve tracked objects. The mean values μ₁, μ₂, μ₃, μ₄ are determined as 10.0, 40.0, 125.0, and 250.0, respectively. Table 410 indicates selected descriptor values Γ(p,q) and table 420 indicates corresponding normalized values.

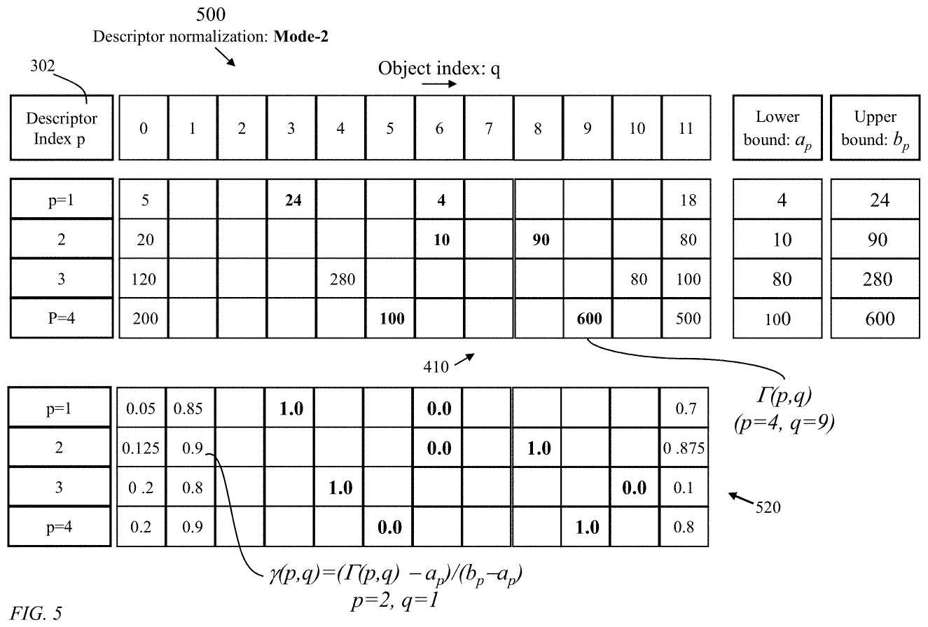

FIG. 5 illustrates second-mode normalization of the four descriptors of 12 tracked objects. The lower bounds and upper bounds of the four descriptors are determined as {4.0, 24.0}, {10.0, 90.0}, {80.0, 280.0}, and {100.0, 600.0}, respectively. Table 520 indicates normalized values corresponding to the selected descriptor values of Table 410 according to second-mode normalization criterion.

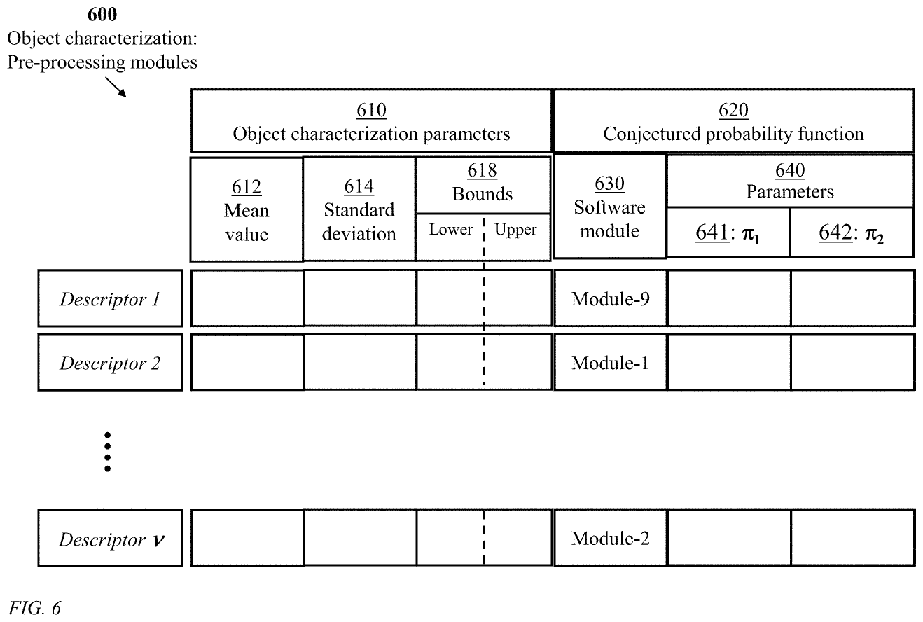

FIG. 6 illustrates a scheme 600 of generating descriptor probability functions based on moments and boundaries of variables (boundaries of descriptor values). Object-characterization parameters 610 include a mean value 612, a standard deviation 614, and bounds 618 of each descriptor. A deduced probability function 620 of each descriptor is determined based on the object-characterization parameters 610. Parameters 640 defining a deduced probability function are determined. It is sufficient to determine a first parameter (π₁) 641 and a second parameter (π₂) 642 of a deduced probability function. The deduced probability functions may be evaluated using software modules 630 to generate candidate centroids.

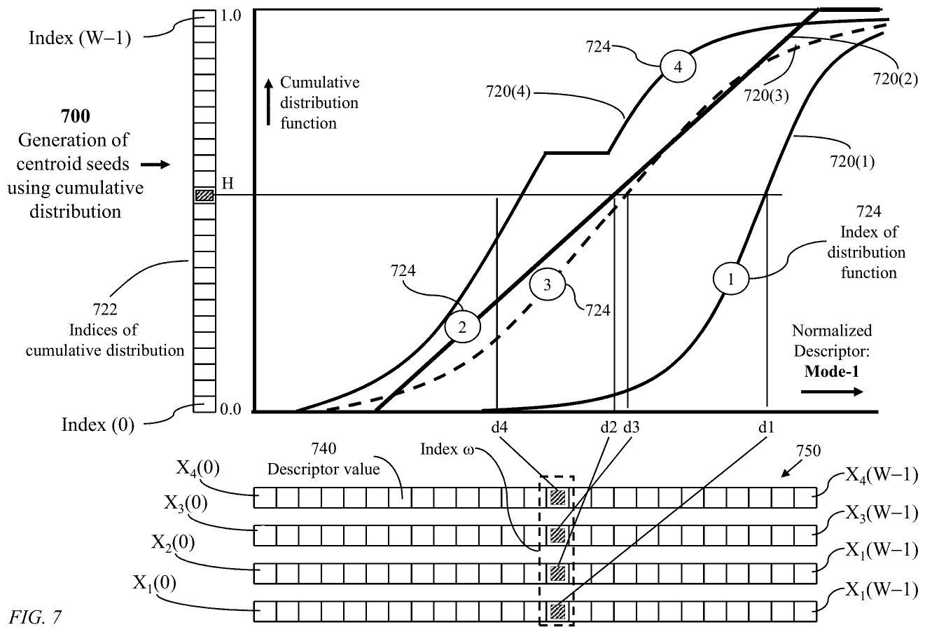

FIG. 7 illustrates a process 700 of generating candidate centroids based on a cumulative distribution function 720 of each descriptor derived according to moments of respective descriptor data where all variables (all descriptor values) are normalized according to the first mode of normalization. Four cumulative distribution functions 720 of descriptors of indices 724 are illustrated.

A set of descriptor values 740 corresponding to a predefined number W, W>>1, of equidistant samples 722 of each cumulative distribution function 720 is determined and stored in arrays 750. Each array 750 corresponds to a variable (a descriptor type) and stores descriptor values ranging from Xₚ(0) to Xₚ(W−1), 1≤p≤v. As illustrated, descriptor values d1, d2, d3, and d4 corresponding to a selected cumulative-distribution index H are stored in respective arrays 750. A descriptor vector of v descriptors is generated by randomly selecting one descriptor value from each of the v arrays 750.

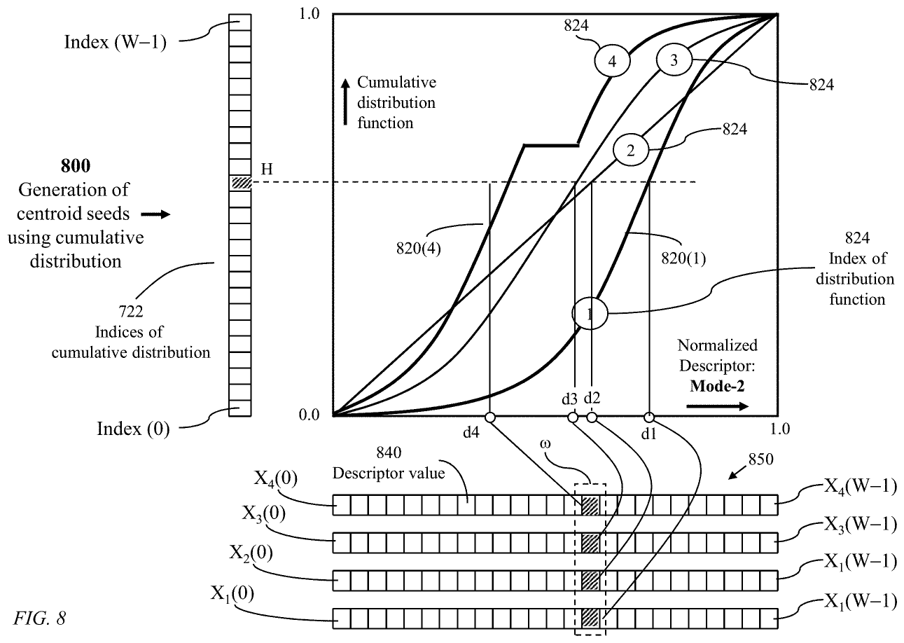

FIG. 8 illustrates a process 800 of generating candidate centroids based on a cumulative distribution function 820 of each descriptor derived according to moments of respective descriptor data where all variables (all descriptor values) are normalized according to the second mode of normalization. Four cumulative distribution functions 820 of descriptors of indices 824 are illustrated.

A set of descriptor values 840 corresponding to a predefined number W, W>>1, of equidistant samples 722 of each cumulative distribution function 820 is determined and stored in arrays 850. Each array 850 corresponds to a variable (a descriptor type) and stores descriptor values ranging from Xₚ(0) to Xₚ(W−1), 1≤p≤v. As illustrated, descriptor values d1, d2, d3, and d4 corresponding to a selected cumulative-distribution index H are stored in respective arrays 850. A descriptor vector of v descriptors is generated by randomly selecting one descriptor value from each of the v arrays 850.

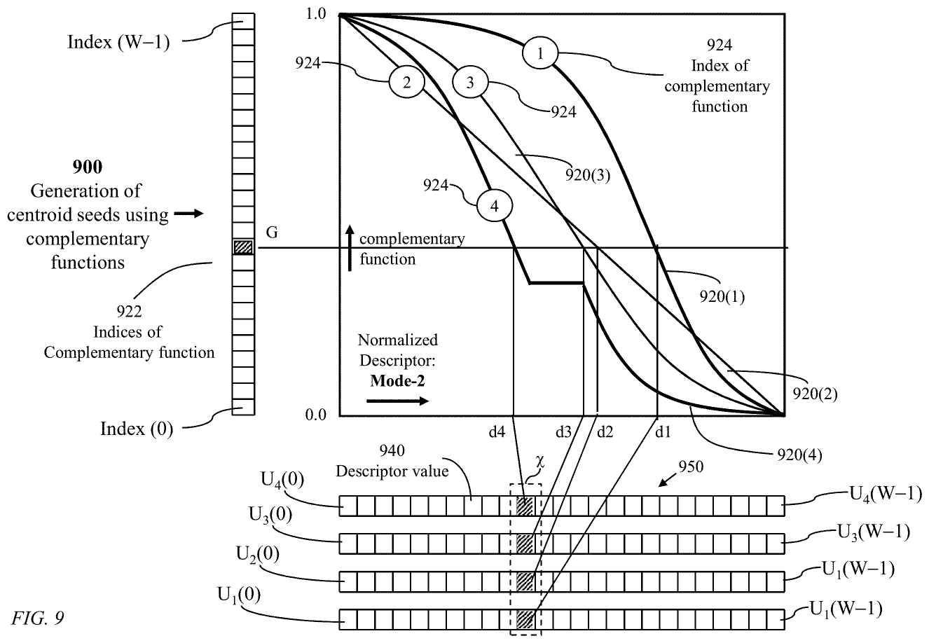

FIG. 9 illustrates a process 900 of generating candidate centroids based on a complementary function 920 of each descriptor derived according to moments of respective descriptor data where all variables (all descriptor values) are normalized according to the second mode of normalization.

A set of descriptor values 940 corresponding to a predefined number W, W>>1, of equidistant samples 722 of each complementary function 920 is determined and stored in arrays 950. Each array 950 corresponds to a variable (a descriptor type) and stores descriptor values ranging from Uₚ(0) to Uₚ(W−1), 1≤p≤v. As illustrated, descriptor values d1, d2, d3, and d4 corresponding to a selected cumulative-distribution index G are stored in respective arrays 950. A descriptor vector of v descriptors is generated by randomly selecting one descriptor value from each of the v arrays 950.

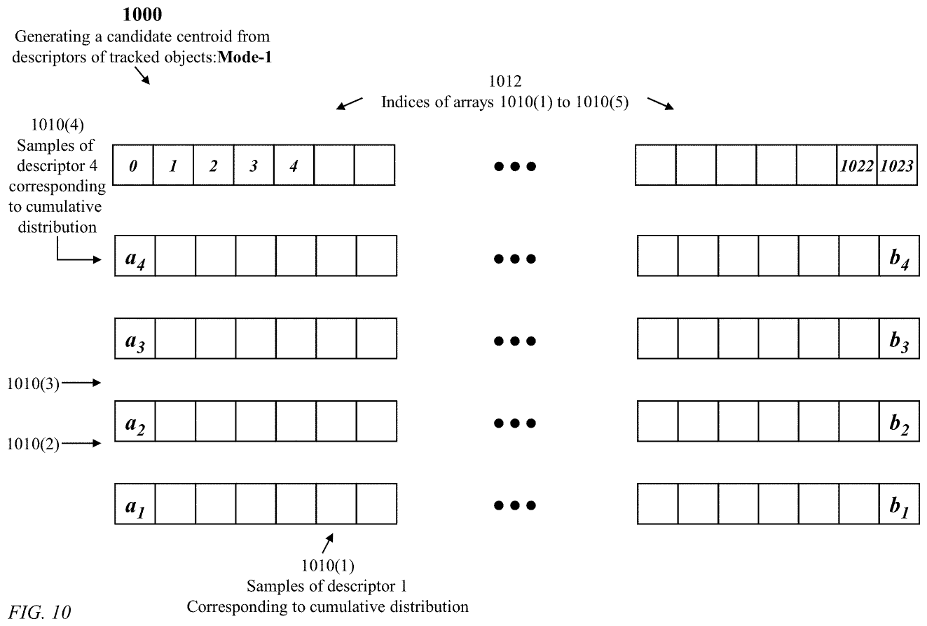

FIG. 10 illustrates a method 1000 of generation of candidate centroids based on sampling the cumulative distribution or complementary function of each descriptor of the collection of tracked objects where the descriptors are normalized according to the first mode. Four Arrays 1010 of samples of a descriptor (1010(p), 1≤p≤v) are illustrated. Each array 1010 stores descriptor values corresponding to 1024 equispaced samples 1012 of a cumulative distribution function or a complementary function. With first-mode descriptor normalization, the minimum value aₚ and maximum value bₚ of a variable of index p, 1≤p≤v, vary according to the descriptor type.

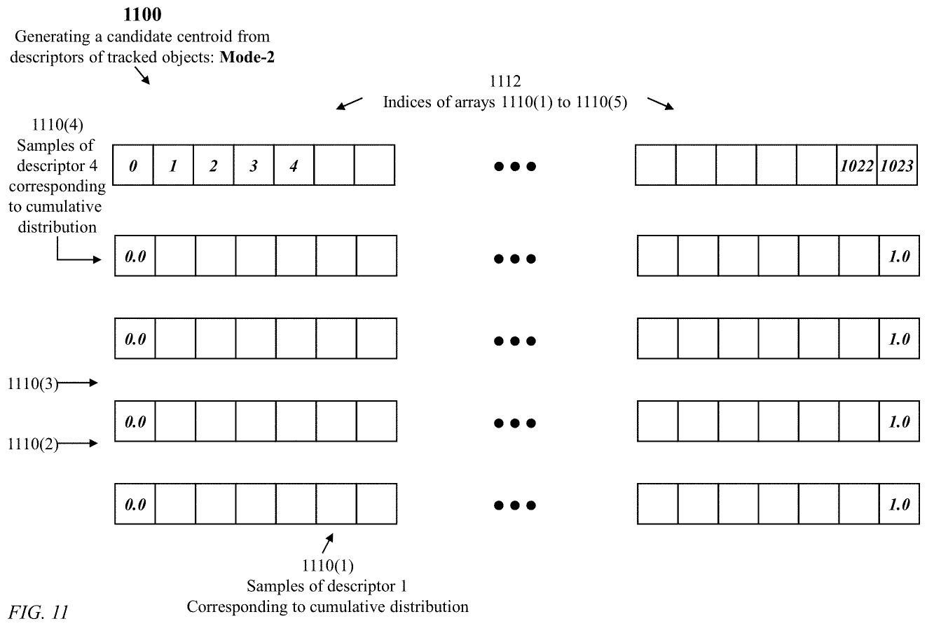

FIG. 11 illustrates a method 1100 of generation of candidate centroids based on sampling the cumulative distribution or complementary function of each descriptor of the collection of tracked objects where the variables (the descriptor values) are normalized according to the second mode. Four arrays 1110(p), 1≤p≤v, of descriptor samples are illustrated. Each array 1110 stores descriptor values corresponding to 1024 equidistant samples 1112 of a cumulative distribution function or a complementary function. With second-mode descriptor normalization, the minimum value of each descriptor is 0.0 and the maximum value of each descriptor is 1.0.

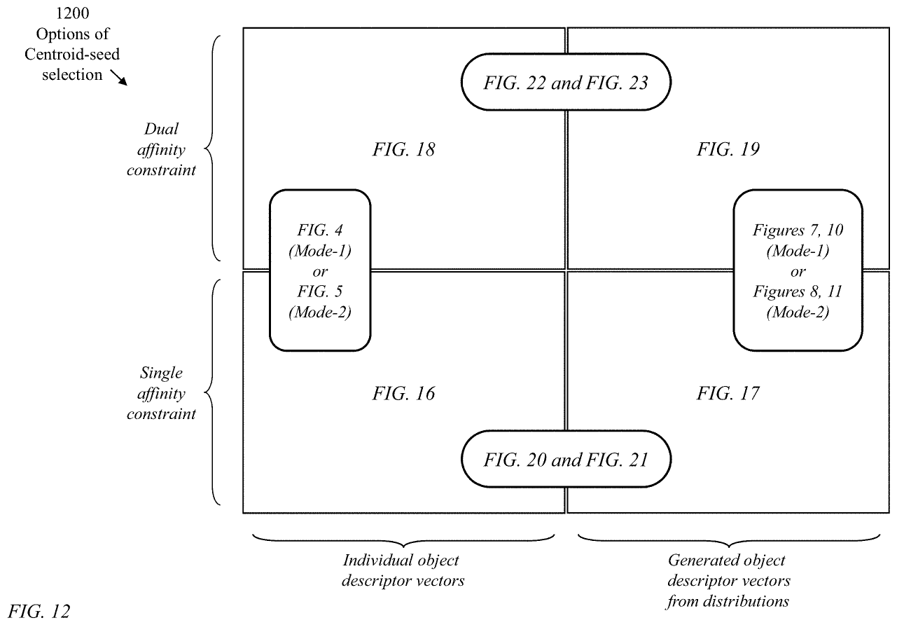

FIG. 12 illustrates options of determining centroids based on different affinity constraints for different descriptor normalization modes and different descriptor-vector selection methods.

The centroids may be generated based on the individual descriptor vectors of the tracked object as illustrated in FIGS. 3, 4, and 5, or from a deduced distribution of each variable as illustrated in FIGS. 7, 8, and 9.

Each variable of the v variables may be normalized according the first-mode normalization criterion as illustrated in FIGS. 4, 7, and 10 or according to the second-mode normalization criterion as illustrated in FIGS. 5, 8, and 11.

The centroids may be determined according to a single affinity threshold (radial or angular) as illustrated in FIGS. 16, 17, 20, and 21. Alternatively, the centroids may be determined according to a dual affinity threshold (radial and angular) as illustrated in FIGS. 18, 19, 22, and 23.

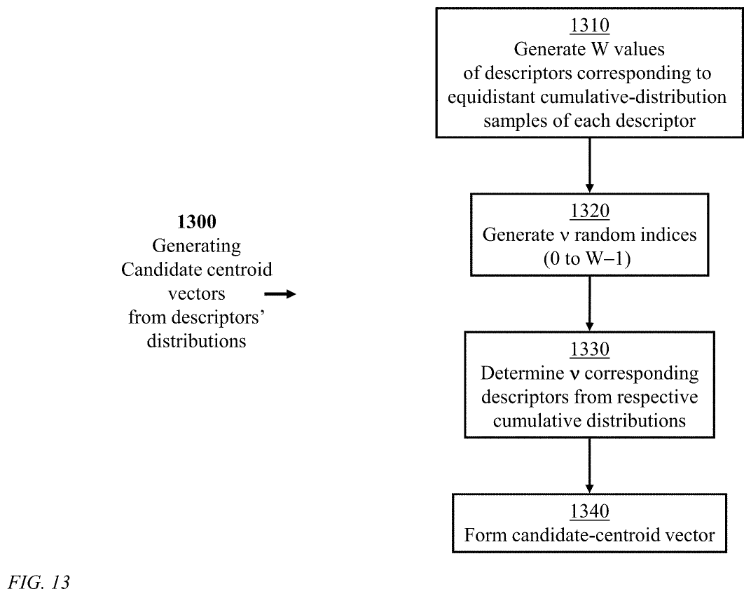

FIG. 13 illustrates a method 1300 of generating candidate centroid vectors based on deriving a cumulative distribution function of each descriptor according to moments of respective descriptor data. For each variable, a set of variable values corresponding to a predefined number W, W>>1, of equispaced samples of a respective cumulative distribution (720, FIG. 7, 820, FIG. 8) or a respective complementary function (920, FIG. 9) is generated (process 1310). Thus, W descriptor vectors each containing v descriptor values are generated. To generate a candidate centroid vector of v descriptors of different types, v random indices each in the range 0 to (W−1) are generated (process 1320), v being the number of variables (the number of descriptor types). Descriptor values corresponding to the v random indices are acquired (process 1330) to form the candidate-centroid vector (process 1340).

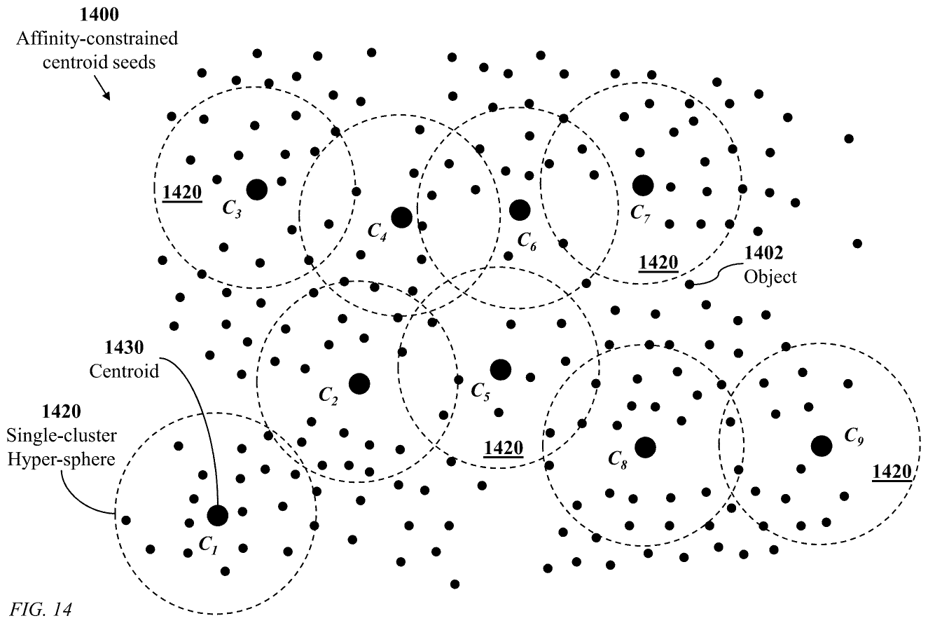

FIG. 14 visualizes a scheme 1400 for selecting centroids 1430 of a plurality of objects 1402 based on inter-centroid affinity constraint. Each object 1402 is characterized by v variables (v descriptors of different descriptor types) and associated with a v-dimensional hypersphere 1420. Likewise, each centroid 1430 is characterized by v descriptors. In one implementation, the radial-affinity level or the angular-affinity level of each centroid to each other centroid is constrained to be less than a respective predefined threshold. In another implementation, the radial-affinity level of each centroid to each other centroid is required to be less than a predefined radial threshold and the angular-affinity level of each centroid to each other centroid is required to be less than a predefined angular threshold.

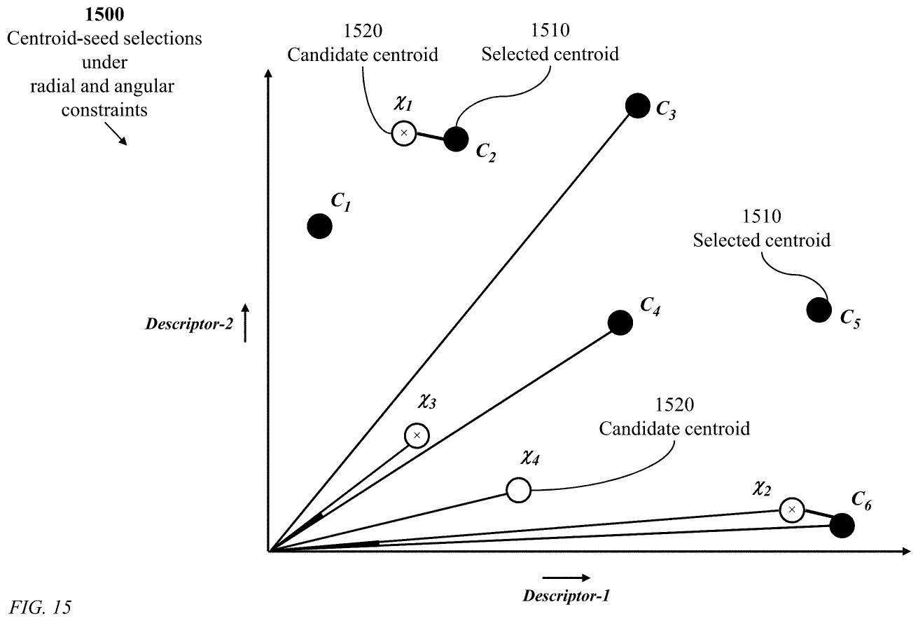

FIG. 15 illustrates an example 1500 of centroid selection under dual radial and angular inter-centroid affinity constraints. With a centroid set of six centroids 1510 labelled C₁, C₂, C₃, C₄, C₅, and C₆, already selected, the radial-affinity level and the angular-affinity level of each of candidate centroids 1520 labelled χⱼ, j=1, 2, etc., to each of the six selected centroids 1510 are determined and respectively compared with the predefined radial threshold and angular threshold. Candidate centroid χ₁ has a high radial affinity to C₂, hence χ₁ is disqualified from joining the centroid set. Candidate centroid χ₂ has a high angular affinity to C₆, hence χ₂ is disqualified. Candidate centroid χ₃ has a high angular affinity to C₄, hence χ₃ is disqualified. The radial-affinity level of candidate centroid χ₄ to each of the six centroids 1510 is below a predefine radial-affinity threshold and the angular-affinity level of candidate centroid χ₄ to each of the six centroids 1510 is below a predefine angular-affinity threshold. Thus, candidate centroid χ₄ is added to the centroid set.

FIG. 16 illustrates a method 1600 of determining a maximum attainable number of centroids based on a specified single affinity threshold and random object selection. The single affinity threshold may be:
a threshold of a radial affinity;
a threshold of an angular affinity;
a threshold of radial affinity together with a proportionate threshold of angular affinity; or
a threshold of a composite radial-angular affinity defined as a weighted sum of a radial-affinity level and an angular-affinity level.

In an initialization process 1602, a centroid set is initialized as an empty set with a zero centroid count. An object from a plurality of objects is selected as a centroid. Each object of the plurality of objects is characterized by a respective descriptor vector.

In a process 1610, the selected object is added to the centroid set and the centroid count is increased. Process 1620 determines whether predefined upper bound K* of the number of centroids has been reached. If so, process 1670 communicates the centroid set to a subsequent process. Otherwise, process 1622 determines whether all tracked objects have been examined for consideration as potential centroids. If all tracked objects have been examined, process 1670 communicates the centroid set to the subsequent process. Otherwise, process 1630 examines another object from the plurality of tracked objects and process 1640 determines object's affinity to each selected centroid. If the object's affinity to any centroid equals or exceeds a predefined affinity threshold, the object is disqualified; otherwise, the examined object qualifies as a new centroid. Process 1650 logically removes the examined object, whether selected as a centroid or not, from the plurality of objects. Process 1650 inherently takes place if the objects of the plurality of objects are examined sequentially. Process 1660 proceeds to process 1610 to add the examined object to the centroid set and increase the centroid count if the examined object is qualified. Otherwise, process 1660 proceeds to process 1630 to select a new object for examination. Process 1620 terminates the build up of the centroid set if the number of centroids reaches the predefined upper bound K* and process 1622 terminates the expansion of the centroid set when all objects have been examined.

FIG. 17 illustrates a method 1700 of determining an attainable number of centroids based on a specified single affinity threshold and generation of candidate centroids based on deduced distributions as illustrated in FIGS. 7, 8, and 9. The single affinity threshold may be any of the forms described above with reference to FIG. 16.

In an initialization process 1702, a centroid set is initialized as an empty set with a zero candidate count and a zero centroid count. A descriptor vector is generated from a deduced distribution and selected as a centroid.

In a process 1710, the descriptor vector is added to centroid set and the centroid count is increased. Process 1720 determines whether a predefined upper bound K* of the number of centroids has been reached. If so, process 1770 communicates the centroid set to a subsequent process. Otherwise, process 1722 determines whether a sufficient number N* of candidate centroids have been generated. If a sufficient number of candidate centroids has been generated and examined, process 1770 communicates the centroid set to the subsequent process. Otherwise, process 1730 generates another candidate centroid from the deduced probability functions and increases the candidate count.

Process 1740 determines the candidate's affinity to each selected centroid. If the candidate's affinity to any centroid equals or exceeds a predefined affinity threshold, the candidate is disqualified; otherwise, the examined candidate qualifies as a new centroid. Process 1760 proceeds to process 1710 to add the examined candidate to the centroid set and increase the centroid count if the examined candidate is qualified. Otherwise, process 1760 leads to process 1730 to generate a new centroid candidate (a new descriptor vector) for examination. Process 1720 terminates the expansion of the centroid set if the number of centroids reaches the predefined upper bound K* and process 1722 terminates the expansion of the centroid set when a user-defined sufficient number N* of candidates (descriptor vectors) have been examined.

Thus, the invention provides a method of generating centroids of a plurality of objects. The method comprises specifying an affinity threshold and employing a processor to execute instructions for: acquiring a descriptor vector of v variables, v>1, for each object of the plurality of objects; initializing a centroid set to include an object of the plurality of objects; and performing for each object of the plurality of objects a procedure for deciding whether the object qualifies as a centroid. The procedure comprises determining an affinity measure to each centroid of the centroid set based on a descriptor vector of the each object and a descriptor vector of the each centroid and selecting the each object as a centroid to be added to the centroid set subject to ascertaining that the affinity measure to the each centroid is less than the affinity threshold. Thereby, the method creates a set of uniformly spaced centroids for use in automated intelligent-marketing systems.

The process of acquiring a descriptor vector comprises normalizing the v variables so that a value of each variable is within a predefined range.

In one implementation, normalizing the v variables comprises scaling the variables so that a mean value of each variable equals 1.0. In another implementation, normalizing the v variables comprises shifting and scaling the variables so that a minimum value and a maximum value of each variable equal 0.0 and 1.0 respectively. In a further implementation, normalizing the v variables comprises shifting and scaling the variables so that a minimum value of each variable equals 0.0 and a maximum value of each variable equals a respective variable-specific positive upper bound not exceeding 1.0.

Performing the procedure for determining whether the object qualifies as a centroid is terminated subject to ascertaining that the set of centroids contains a number of centroids equal to a predefined upper bound.

The method further comprises generating non-repeating randomly sequenced indices of objects of the plurality of objects; and selecting objects of the plurality of objects at indices corresponding to the randomly sequenced indices.

The process of determining an affinity measure comprises computing a radial affinity level and an angular-affinity level between each object and each centroid, and computing the affinity measure as a function of the radial-affinity level and the angular-affinity level. The function may be selected as a weighted sum of the radial-affinity level and the angular-affinity level.

In one embodiment, the process of ascertaining that the affinity measure to each centroid is less than the affinity threshold comprises verifying that: the radial-affinity level is less than the radial-affinity threshold; and the angular-affinity level is less than the angular-affinity threshold.

FIG. 18 illustrates a method 1800 of determining an attainable number of centroids based on specified dual radial-angular affinity thresholds based on descriptors of tracked objects.

In an initialization process 1602, a centroid set is initialized as an empty set with a zero centroid count. An object from a plurality of objects is selected as a centroid. Each object of the plurality of objects is characterized by a respective descriptor vector.

In a process 1610, the selected object is added to the set of centroids and the centroid count is increased. Process 1620 determines whether a predefined upper bound K* of the number of centroids has been reached. If so, process 1670 communicates the centroid set to a subsequent process. Otherwise, process 1622 determines whether all tracked objects have been examined for consideration as potential centroids. If all tracked objects have been examined, process 1670 communicates the centroid set to the subsequent process. Otherwise, process 1630 examines another object from the plurality of tracked objects and process 1840 determines the object's radial affinity to each selected centroid.

Process 1850 logically removes the examined object, whether selected as a centroid or not, from the plurality of objects. Process 1850 inherently takes place if the objects of the plurality of objects are examined sequentially.

If the object's radial affinity to any centroid equals or exceeds a predefined radial-affinity threshold, the object is disqualified and process 1860 proceeds to process 1630 to select another object. Otherwise, process 1860 proceeds to process 1845 to determine the object's angular affinity to the centroid set. If the angular affinity to any centroid equals or exceeds a predefined angular-affinity threshold, process 1865 proceeds to process 1630 to select another object. Otherwise, process 1865 proceeds to process 1610 to add the examined object to the centroid set and increase the centroid count. Process 1620 terminates the expansion of the centroid set if the number of centroids reaches the predefined upper bound K* and process 1622 terminates the expansion of the centroid set when all objects have been examined.

FIG. 19 illustrates a method 1900 of determining an attainable number of centroids based on specified dual radial-angular affinity constraints and generation of candidate centroids based on deduced distributions as illustrated in FIGS. 7, 8, and 9. The single affinity threshold may be any of the forms described above with reference to FIG. 16.

In an initialization process 1702, a centroid set is initialized as an empty set with a zero candidate count and a zero centroid count. A descriptor vector is generated from a deduced distribution and selected as a centroid.

In a process 1710, the descriptor vector is added to the set of centroids and the centroid count is increased. Process 1720 determines whether a predefined upper bound K* of the number of centroids has been reached. If so, process 1770 communicates the centroid set to a subsequent process. Otherwise, process 1722 determines whether a sufficient number N* of candidate centroids have been generated. If a sufficient number of candidate centroids has been generated and examined, process 1770 communicates the centroid set to the subsequent process. Otherwise, process 1730 generates another candidate centroid from deduced probability functions and increases the candidate count.

Process 1940 determines the candidate's radial affinity to each selected centroid. If the candidate's radial affinity to any centroid equals or exceeds a predefined radial-affinity threshold, the candidate is disqualified and process 1760 leads to process 1730 to generate a new centroid candidate (a new descriptor vector) for examination. Otherwise, process 1960 proceeds to process 1945 to determine the object's angular affinity to the centroid set. If the angular affinity to any centroid equals or exceeds a predefined angular-affinity threshold, process 1965 proceeds to process 1730 to generate a new centroid candidate (a new descriptor vector) for examination. Otherwise, process 1865 proceeds to process 1710 to add the examined descriptor vector to the centroid set and increase the centroid count. Process 1720 terminates the expansion of the centroid set if the number of centroids reaches the predefined upper bound K* and process 1722 terminates the expansion of the centroid set when a sufficient number N* of candidates (descriptor vectors) have been examined.

Thus, the invention provides a method (FIGS. 16-19) of creating centroids of a plurality of objects. The method comprises specifying an affinity threshold and employing a processor to execute instructions for acquiring, for each object of the plurality of objects, a respective characterizing vector of v variables, v>1, and deducing for each variable a respective cumulative distribution function to produce v cumulative distribution functions. The instructions further cause the processor to execute processes of initializing a centroid set as an empty set, generating a succession of descriptor vectors each comprising v variables, and performing for each descriptor vector of the succession of descriptor vectors a procedure for descriptor-vector election as a centroid vector.

The procedure comprises processes of determining an affinity measure to each centroid of the centroid set based on the each descriptor vector and a descriptor vector of each centroid, and assigning the each descriptor vector to the centroid set as a centroid subject to ascertaining that the affinity measure to the each centroid is less than the affinity threshold.

Thus, the method creates a set of uniformly spaced centroids for use in automated intelligent-marketing systems.

The process of generating a succession of descriptor vectors comprises randomly indexing an inverse of a cumulative distribution function of each variable of the v variables to determine v variable values forming a descriptor vector of the succession of descriptor vectors.

In one implementation, the process of acquiring the respective characterizing vector of v variables comprises normalizing each of the v variables to be within a predefined range.

In another implementation, the process of acquiring the respective characterizing vector of v variables comprises assigning for each variable a respective variable-specific weight greater than 0.0 and not exceeding 1.0, then shifting and scaling each of the variables so that: a minimum value of each variable equals 0.0; and a maximum value of each variable equals a corresponding variable-specific weight.

The affinity measure to the empty centroid set is assigned a value of zero.

The method terminates performing the procedure for descriptor vector election as a centroid vector upon determining that a count of centroids of the set of centroids equals a predefined upper bound.

The process of determining an affinity measure comprises computing a radial affinity level and an angular-affinity level between each descriptor vector and each centroid, and computing the affinity measure as a function of the radial-affinity level and the angular-affinity level. The function may be formed as a weighted sum of the radial-affinity level and the angular-affinity level.

In one implementation, the process of specifying an affinity threshold comprises itemizing the affinity threshold as a radial-affinity threshold and an angular-affinity threshold. Accordingly, the process of determining an affinity measure comprises computing a radial affinity level and an angular-affinity level between the each descriptor vector and each centroid. Subsequently, ascertaining that the affinity measure to each centroid is less than the affinity threshold comprises verifying that the radial-affinity level is less than the radial-affinity threshold and the angular-affinity level is less than the angular-affinity threshold.

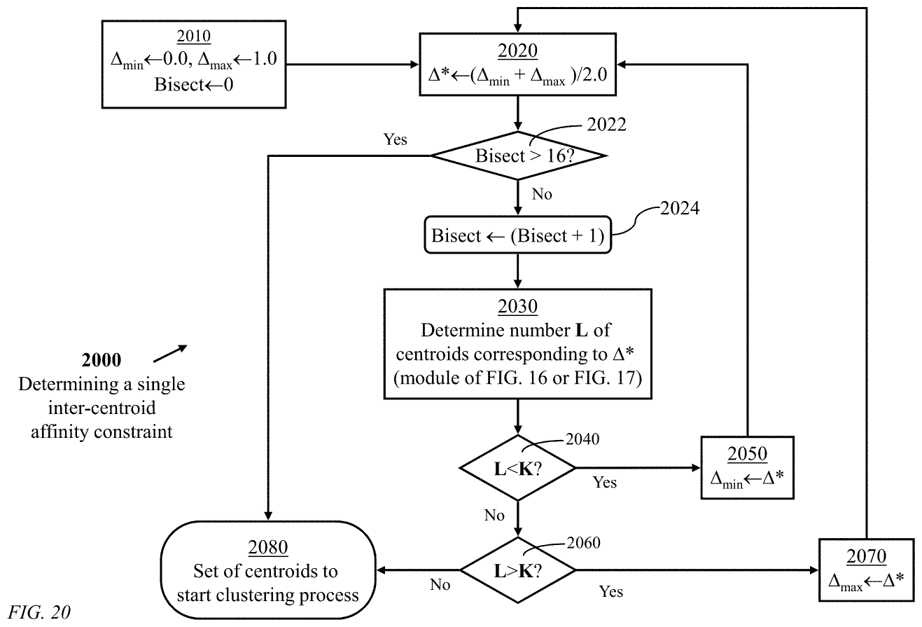

FIG. 20 illustrates a method 2000 of determining a single inter-centroid affinity threshold (radial, angular, proportionate, or composite as described above with respect to FIG. 16) to yield a target number of centroids. The method is based on determining a maximum attainable number of centroids corresponding to an affinity threshold selected as a mid point between a lower bound Δₘᵢₙ and upper bound Δₘₐₓ and adjusting the lower bound or upper bound according to the attainable number. Process 2010 initializes a lower bound and an upper bound of inter-centroid affinity constraints and sets a bisection counter to zero. Process 2020 starts a sequence of bisection cycles and determines a candidate value Δ* of inter-centroid single affinity constraint as the mid value between the lower bound and the upper bound. Process 2022 limits the number of iterative bisection-search cycles to a predefined number β, β>1, so that the relative smallest search interval ε (the upper bound minus the lower bound), ε=2^{-β}, is infinitesimally small (ε=2^{-β}); for example, setting β=20, ε<10⁻⁶.

Process 2024 counts the bisection cycles. Process 2030 determines a maximum attainable number L of centroids corresponding to a given inter-centroid single affinity constraint using the method of FIG. 16 or the method of FIG. 17. Process 2040 compares of the maximum number of attainable centroids to a target number K of centroids. If the number L of attainable centroids is less than the target number K, process 2050 increases the lower bound Δₘᵢₙ of inter-centroid affinity constraint to equal Δ* and process 2020 is revisited. If process 2040 determines that L equals or exceeds K, process 2060 is executed to branch to either process 2070 if L is greater than K or to process 2080 if L equals K. Process 2070 decreases the upper bound Δₘₐₓ of inter-centroid affinity constraint to equal Δ* and revisits process 2020. Process 2080 stores the set of selected centroids to be communicated to a subsequent process.

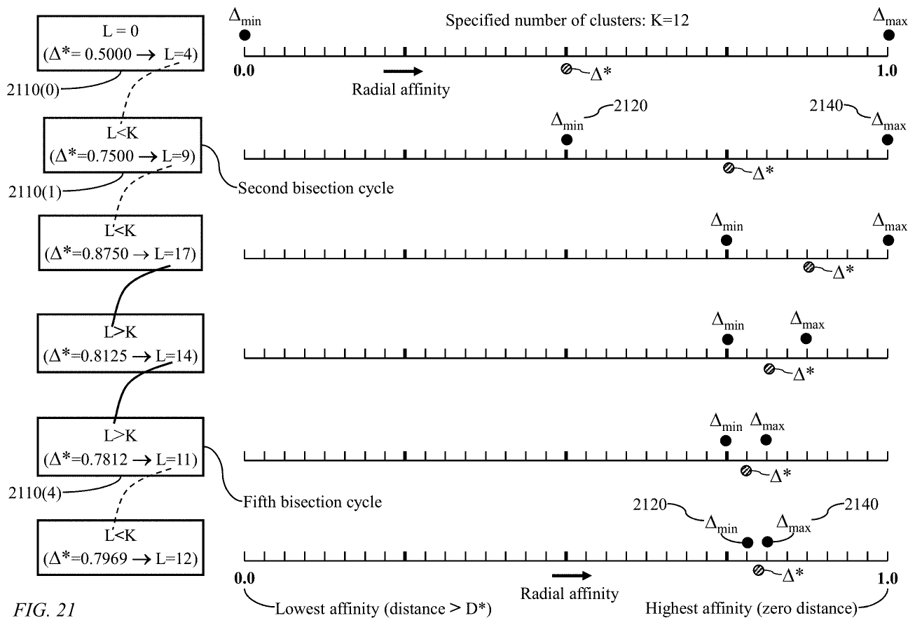

FIG. 21 illustrates six bisection cycles of the method of FIG. 20 for a target number of 12 centroids (K=12). Initially, the number, L, of attainable centroids is unknown and set to equal zero. With the inter-centroid radial affinity or angular affinity normalized to vary between 0.0 and 1.0, the lower bound Δₘᵢₙ is set to 0.0 and the upper bound Δₘₐₓ is set to 1.0 (process 2010). For each bisection cycle, a lower bound 2120 of inter-centroid affinity constraint, an upper bound 2140 of inter-centroid affinity constraint, a candidate value of inter-centroid affinity constraint and resulting number L of attainable centroids are indicated (reference 2110).

In a first bisection cycle, process 2020 determines Δ* as 0.5 and process 2030 determines that the number of attainable centroids is four (L=4). Since L<K, process 2050 increases Δₘᵢₙ from 0.0 to Δ*, which is currently 0.5.

In a second bisection cycle, process 2020 determines Δ* as 0.75 and process 2030 determines that the number of attainable centroids is nine (L=9). Since L<K, process 2050 increases Δₘᵢₙ from 0.5 to Δ*, which is currently 0.75.

In a third bisection cycle, process 2020 determines Δ* as (0.75+1.0)/2, which is 0.875, and process 2030 determines that the number of attainable centroids is seventeen (L=17). Since L>K, process 2060 decreases Δₘₐₓ from 1.0 to Δ*, which is currently 0.875.

In a fourth bisection cycle, process 2020 determines Δ* as (0.75+0.875)/2, which is 0.8125, and process 2030 determines that the number of attainable centroids is fourteen (L=14).

Since L>K, process 2060 decreases Δₘₐₓ from 0.875 to Δ*, which is currently 0.8125.

In a fifth bisection cycle, process 2020 determines Δ* as (0.75+0.8125)/2, which is 0.78125, and process 2030 determines that the number of attainable centroids is fourteen (L=11). Since L<K, process 2050 increases Δₘᵢₙ from 0.75 to Δ*, which is currently 0.78125.

In a six bisection cycle, process 2020 determines Δ* as (0.78125+0.8125)/2, which is 0.796875, and process 2030 determines that the number of attainable centroids is twelve (L=12). Since L=K, processes 2040 and 2060 lead to process 2080 and the latest centroid set determined in process 2030 is used for starting segmentation of the plurality of objects into K clusters.

It is possible that equality of the number L of attainable centroids to the target number K of centroids would never be reached where by continuing the bisection cycles, the number L may oscillate ad infinitum between a number L₁ that is less than K and a number L₂ that is higher than K. For this reason, process 2022 limits the number of bisection cycles to a predefined value β. After β bisection cycles, the search interval {Δₘₐₓ−Δₘᵢₙ} is reduced to 2^{-β} of the range of affinity levels. For β=20, for example, the search interval is reduced to less than one millionth of the range of affinity levels and the centroid set of L₁ centroids or the centroid set of L₂ centroids may be selected. For example, with a target of 100 centroids, the number of attainable centroids (process 2030) may oscillate between 98 and 101 in which case the latter may be preferred.

Thus, the invention provides a method (FIG, 20 and FIG. 21) of creating centroids of a plurality of objects. The method comprises specifying a target number of centroids and an affinity threshold, and defining bounds of v variables, v>1, each object of the plurality of objects being characterized by a respective vector of descriptors of the v variables within the bounds. A processor is employed to execute instructions for generating a maximal centroid set comprising a maximum attainable number of centroids selected from the plurality of objects conditional on an affinity measure of each centroid to each other centroid being less than the affinity threshold. Where the maximum attainable number differs from the target number, the instructions further cause the processor to execute processes of iteratively tuning the affinity threshold and generating the centroid set until the maximum attainable number equals the target number or a predefined permissible number of iterations is reached. The maximal centroid set is stored for starting a segmentation process of the plurality of objects.

Tuning the affinity threshold comprises increasing the affinity threshold subject to a determination that the maximum attainable number is less than the target number, or decreasing the affinity threshold subject to a determination that the maximum attainable number exceeds the target number.

Generating a centroid set comprises initializing the centroid set as an empty set of zero count of centroids and performing for each object processes of: determining an affinity measure to each centroid of the centroid set; and adding the each object to the centroid set, updating the count of centroids, subject to ascertaining that the affinity measure to each centroid is less than the affinity threshold. When all objects are considered, the count of centroids becomes the maximum attainable number of centroids. In one implementation, the affinity measure is determined as a composite radial-angular affinity measure formulated as a function of a radial-affinity level and an angular affinity level and the affinity threshold is determined as a specific value of the composite radial-angular affinity measure.

Alternatively, generating the centroid set comprises initializing the centroid set as an empty set of zero count of centroids and performing for each object processes of: determining a radial affinity level and an angular affinity level to each centroid of the centroid set; and adding the each object to the centroid set, updating the count of centroids, subject to ascertaining that the radial affinity level to the each centroid is less than a predefined radial threshold and the angular affinity level to the each centroid is less than the angular threshold. When all objects are considered, the count of centroids becomes the maximum attainable number of centroids.

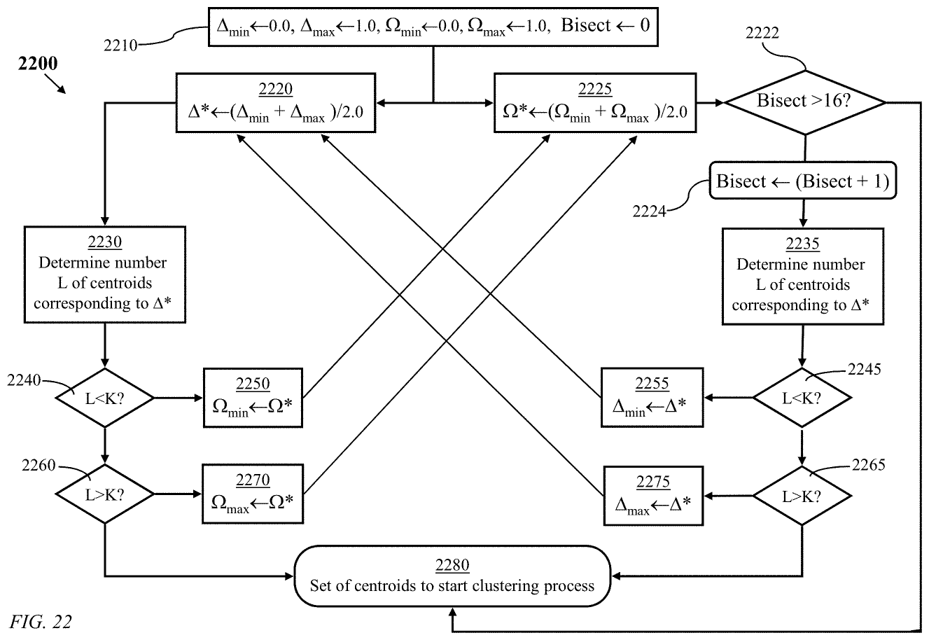

FIG. 22 illustrates a method 2200 of determining a dual radial-angular inter-centroid affinity threshold corresponding to a target number K of centroids. The method is based on determining a maximum attainable number of centroids corresponding to a dual radial-angular affinity threshold between a lower bound and an upper bound and iteratively adjusting the lower bound or upper bound according to the attainable number. The attainable number of centroids is determined based on:
a radial affinity threshold Δ* selected as a mid point between a lower bound Δₘᵢₙ and upper bound Δₘₐₓ; and
an angular affinity threshold Ω* selected as a mid point between a lower bound Ωₘᵢₙ and upper bound Ωₘₐₓ.

Process 2210 initializes a lower bound Δₘᵢₙ and an upper bound Δₘₐₓ of inter-centroid radial-affinity thresholds, a lower bound Ωₘᵢₙ and an upper bound Ωₘₐₓ of inter-centroid radial-affinity thresholds, and sets a bisection counter to zero. Process 2220 starts a sequence of bisection cycles by determining a candidate value Δ* of inter-centroid single affinity constraint as the mid value between the lower bound Δₘᵢₙ and the upper bound Δₘₐₓ.

Process 2230 determines a number L of attainable centroids corresponding to current values of the inter-centroid radial-affinity constraint Δ* and angular-affinity constraint Ω* using the method of FIG. 18 or the method of FIG. 19. Process 2240 compares of the number of attainable centroids to the target number K of centroids. If the number L of attainable centroids is less than the target number K, process 2250 increases the lower bound Ωₘᵢₙ of inter-centroid angular-affinity constraint to equal Ω* and process 2225 is executed. If process 2240 determines that L equals or exceeds K, process 2260 is executed to branch to process 2070 if L is greater than K or to process 2280 if L equals K. Process 2270 decreases the upper bound Qₘₐₓ of inter-centroid angular-affinity constraint to equal Ω* and process 2225 is executed. Process 2080 stores the set of selected centroids to be communicated to a subsequent process.

Process 2225 determines a candidate value Ω* of inter-centroid angular-affinity constraint as the mid value between the lower bound Ωₘᵢₙ and the upper bound Ωₘₐₓ. Process 2222 limits the number of iterative bisection-search cycles to a value β, β>1, so that the relative smallest search interval ε=2^{-β} is infinitesimally small; for example, setting β=16, ε≈0.0000153. Process 2224 counts the bisection cycles.

Process 2235 determines a number L of attainable centroids corresponding to current values of the inter-centroid radial-affinity constraint Δ* and angular-affinity constraint Ω* using the method of FIG. 18 or the method of FIG. 19. Process 2245 compares of the number of attainable centroids to the target number K of centroids. If the number L of attainable centroids is less than the target number K, process 2255 increases the lower bound Δₘᵢₙ of inter-centroid affinity constraint to equal Δ* and process 2220 is executed. If process 2245 determines that L equals or exceeds K, process 2265 is executed to branch to process 2075 if L is greater than K or to process 2280 if L equals K. Process 2275 decreases the upper bound Δₘᵢₙ of inter-centroid affinity constraint to equal Δ* and process 2220 is executed. Process 2280 stores the set of selected centroids to be communicated to a subsequent process.

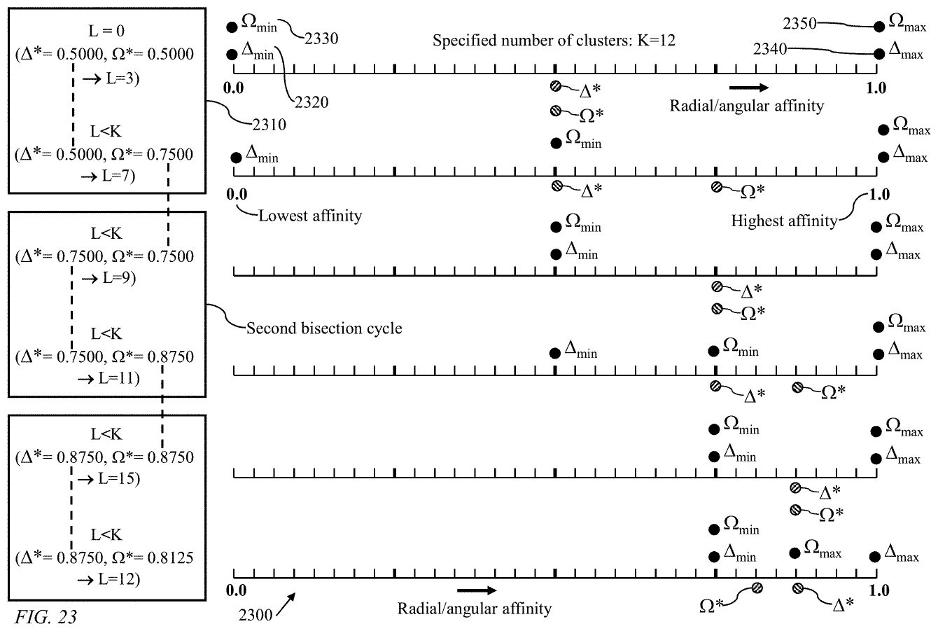

FIG. 23 illustrates iterative processes of the method of FIG. 22 for a target number of 12 centroids (K=12). Initially, the number, L, of attainable centroids is unknown and set to equal zero. A lower bound 2320 of inter-centroid radial affinity threshold (denoted Δₘᵢₙ), a lower bound 2330 of inter-centroid angular affinity threshold (denoted Ωₘᵢₙ), an upper bound 2340 of inter-centroid radial affinity threshold (denoted Δₘₐₓ), and an upper bound 2350 of inter-centroid angular affinity threshold (denoted Ωₘₐₓ) are initialled and modified during successive bisection cycles. The thresholds used in each bisection cycle and the resulting number L of attainable centroids are indicated (reference 2310).

With the inter-centroid radial affinity or angular affinity normalized to vary between 0.0 and 1.0, process 2210 initializes the lower bound Δₘᵢₙ to equal 0.0, the upper bound Δₘₐₓ to equal 1.0, the lower bound Ωₘᵢₙ to equal 0.0 and the upper bound Ωₘₐₓ to equal 1.0. The initial angular-affinity threshold Ω* is set to equal 0.5 and a bisection counter is initialized to equal 0.

In a first bisection cycle, process 2220 determines Δ* as 0.5 and process 2030 determines that the number of attainable centroids is three (L=3) based on the current thresholds Δ* of 0.5 (determined in process 2220) and Ω* of 0.5 (initialized in process 2210). Since L is less than K, process 2250 increases Ωₘᵢₙ from 0.0 to Ω*, which is currently 0.5, and proceeds to process 2225. Process 2225 determines a new value of Ω* as (Ωₘᵢₙ+Ωₘₐₓ)/2 which is 0.75. Process 2235 determines the number of attainable centroids to be seven (L=7). Since L is less than K, process 2245 proceeds to process 2255 which increases Δₘᵢₙ from the current value of 0.0 to the current value of Δ*, which is 0.5.

In a second bisection cycle, process 2220 determines Δ* as (Δₘᵢₙ+Δₘₐₓ)/2, which is (0.5+1.0)/2 and process 2030 determines that the number of attainable centroids, with Δ*=0.75 and Ω*=0.75, is nine (L=9). Since L is less than K, process 2250 increases Ωₘᵢₙ from 0.5 to Ω*, which is currently 0.75.

Process 2225 determines Ω* as (0.75+1.0)/2, which is 0.875, and process 2235 determines that the number of attainable centroids, with Δ*=0.75 and Ω*=0.875, is eleven (L=11). Since L is less than K, process 2255 increases Δₘᵢₙ from 0.5 to Δ*, which is currently 0.75.

In a third bisection cycle, process 2220 determines Δ* as (0.75+1.0)/2, which is 0.875, and process 2230 determines that the number of attainable centroids, with Δ*=0.875 and Ω*=0.875, is fifteen (L=15). Since L is greater than K, process 2270 decreases Ωₘₐₓ from 1.0 to Ω*, which is currently 0.875.

Process 2225 determines Ω* as (0.75+0.875)/2, which is 0.8125, and process 2235 determines that the number of attainable centroids is twelve (L=12). Since L=K, processes 2245 and 2265 lead to process 2280 and the latest centroid set determined in process 2235 is used for starting segmentation of the plurality of objects into K clusters.

Thus, the invention provides a method (FIG. 22, FIG. 23) of creating centroids of a plurality of objects. The method comprises specifying a target number of centroids, a radial threshold, and an angular threshold, and defining bounds of v variables, v>1, each object of the plurality of objects being characterized by a respective vector of descriptors of the v variables within the bounds. A processor is employed to execute instructions for generating a maximal centroid set comprising a maximum attainable number of centroids selected from the plurality of objects conditional on a radial affinity level of each centroid to each other centroid being less than the radial threshold and an angular affinity level of each centroid to each other centroid being less than the angular threshold. Upon determining that the maximum attainable number of centroids differs from the target number, the instructions cause the processor to execute processes of iteratively tuning the radial threshold and the angular threshold, and generating the centroid set until the maximum attainable number equals the target number or a predefined permissible number of iterations is reached. The generated maximal centroid set is stored for use in a segmentation process of the plurality of objects.

Tuning the radial threshold and the angular threshold comprises increasing at least one of the radial and the angular thresholds subject to a determination that the maximum attainable number is less than the target number, or decreasing at least one of the radial and the angular thresholds subject to a determination that the maximum attainable number exceeds the target number.

Generating the centroid set comprises initializing a centroid set as an empty set of zero count of centroids and performing for each object processes of: determining a radial affinity level and an angular affinity level to each centroid of the centroid set; and adding the each object to the centroid set and updating the count of centroids subject to ascertaining that the radial affinity level to each centroid is less than the radial threshold and the angular affinity level to each centroid is less than the angular threshold. When all objects are considered, the count of centroids becomes the maximum attainable number of centroids.

The method further comprises determining the radial threshold as a mean value of a radial lower bound and a radial upper bound, and determining the angular threshold as a mean value of an angular lower bound and an angular upper bound.

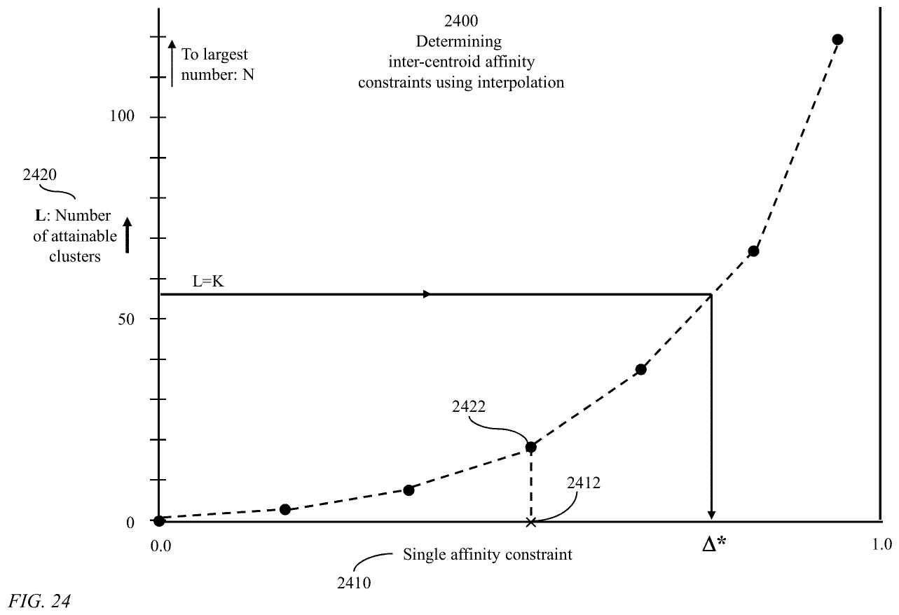

FIG. 24 illustrates a method 2400 of determining a single inter-centroid affinity constraint corresponding to a target number of centroids based on characterizing dependence of the number 2420 of attainable centroids on an affinity threshold 2410. For each of selected values 2412 of inter-centroid affinity thresholds, an attainable number 2422 of centroids is determined using the method illustrated in FIG. 16 or FIG. 17. A threshold Δ* corresponding to K attainable centroids may then be determined by interpolation and the corresponding centroid vectors may be determined using the method illustrated in FIG. 16 or FIG. 17.

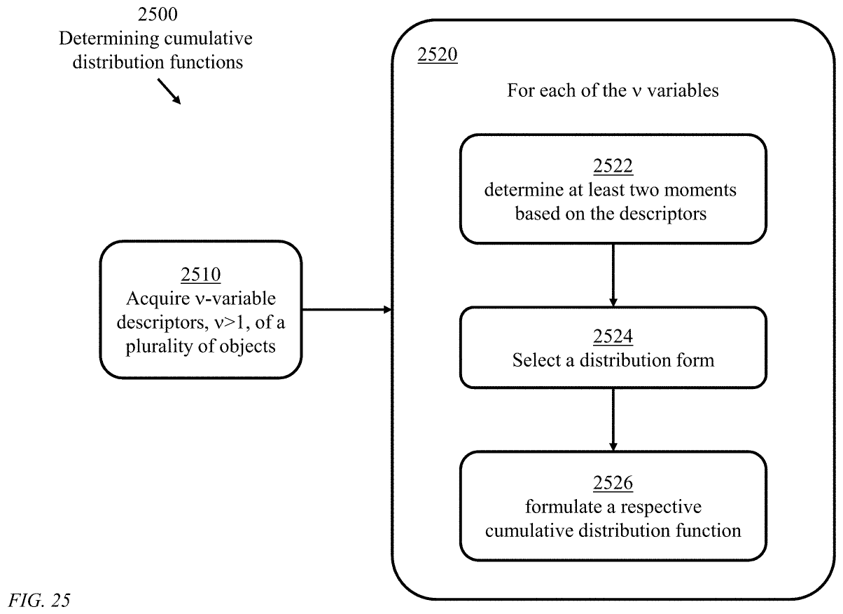

FIG. 25 illustrates a method 2500 of determining cumulative distribution functions for v variables characterizing a plurality of objects under consideration, v>1. Process 2510 acquires descriptors of multiple variables of a plurality of objects to be used for formulating a cumulative distribution function for each variable in processes 2520. Process 2522 determines at least two moments for each variable. Process 2524 selects a form of a distribution function for each variable. The form of distribution may be one of canonical distributions, such as the Gamma distribution, or a customized distribution, such as a piece-wise linear distribution. The distribution form may be user conjectured or determined automatically according to asymmetry (skewness) of the probability-density distribution if a third moment is determined. Process 2526 formulates a cumulative distribution function based on moments determined in process 2522 and a distribution form (model) determined in process 2524.

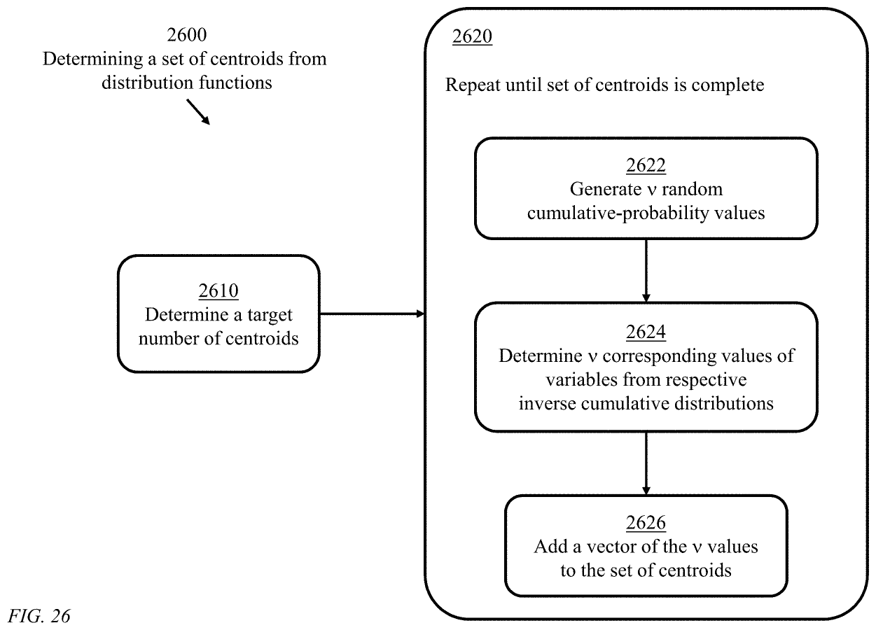

FIG. 26 illustrates a method 2600 of determining a set of centroids from distribution functions of multiple variables characterizing the plurality of objects. Process 2610 determines a target number of centroids which may be based on direct user selection or computed according to user-defined constraints.

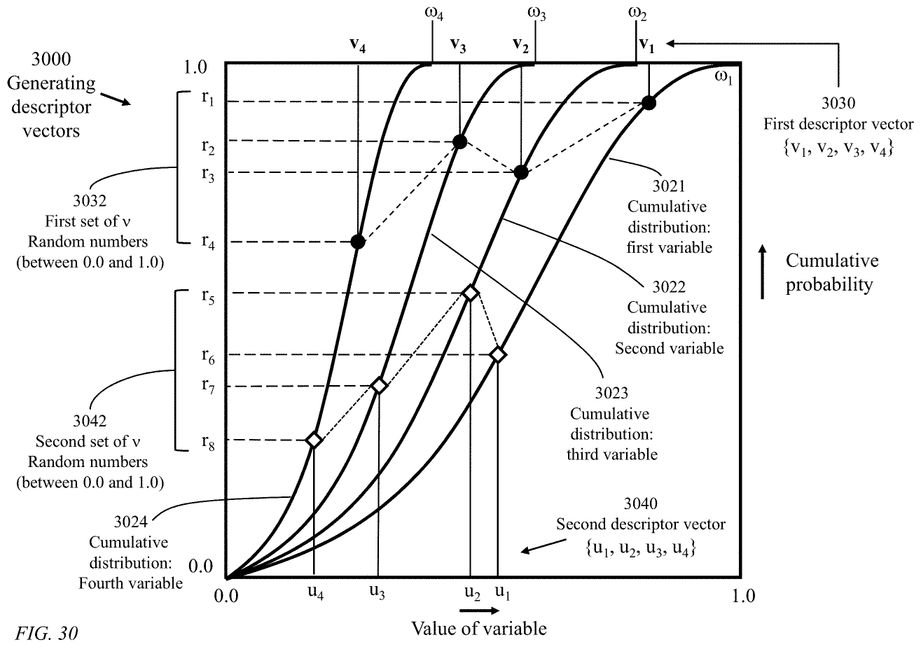

Processes 2620 generate the centroids. Process 2622 generates v random number, each bounded between 0.0 and 1.0, inclusive, each generated random number representing a cumulative distribution value. Process 2624 determines values of v variables (representing a new centroid) corresponding to the v random cumulative distribution values as illustrated in FIG. 30. The value of each of the v variables is based on (inverse) cumulative distribution functions of the v variables determined in process 2526 (FIG. 25). Process 2626 forms a new centroid as a vector of the values of variables, and adds the new centroids to a target set of centroids.

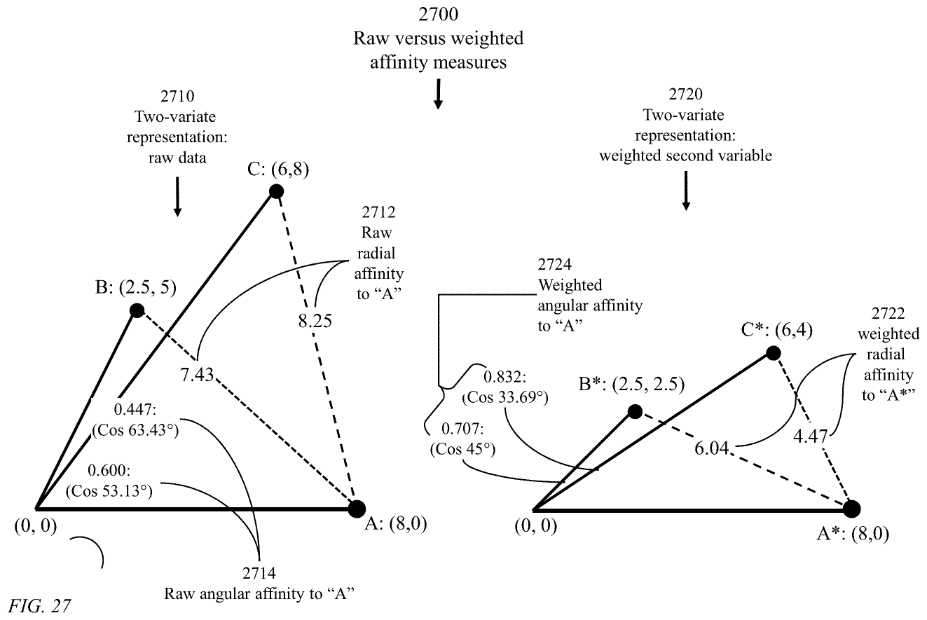

FIG. 27 illustrates a comparison 2700 between affinity levels based on raw variables and affinity levels based on weighted variables where the number of variables v of variables is only two (for ease of illustration).

A first representation 2710 corresponds to raw descriptor vectors A, B, and C, based on raw values of the two variables, having values of {8.0, 0.0}, {2.5, 5}, and {6.0, 8.0}. Descriptor vector “A” may represent a centroid while descriptor vectors “B” and “C” may represent object-B and object-C, respectively. The (unnormalized) radial-affinity levels 2712 of object-B and object-C with respect to the centroid, based on descriptor vectors “B” and “C”, are 7.53 and 8.25, respectively. The corresponding angular-affinity levels 2714 of object-B and object-C with respect to the centroid are 0.600 and 0.447.

A second representation 2720 corresponds to weighted descriptor vectors A*, B*, and C*, where a weight of 0.5 is applied to the second variable of each descriptor. Thus, A*, B*, and

C*, have values of {8.0, 0.0}, {2.5, 2.5}, and {6.0, 4.0}. The (unnormalized) radial-affinity levels 2722 of object-B and object-C with respect to the centroid, based on descriptor vectors “B*” and “C*”, are 6.04 and 4.47, respectively. The corresponding angular-affinity levels 2724 of object-B and object-C with respect to the centroid are 0.832 and 0.707.

Generally, applying a weight of a value less than 1.0 to a variable lessens the contribution of the variable to the overall process of centroid selection. Thus, variable-specific weights may be applied according to perceived importance of each of the v variables.

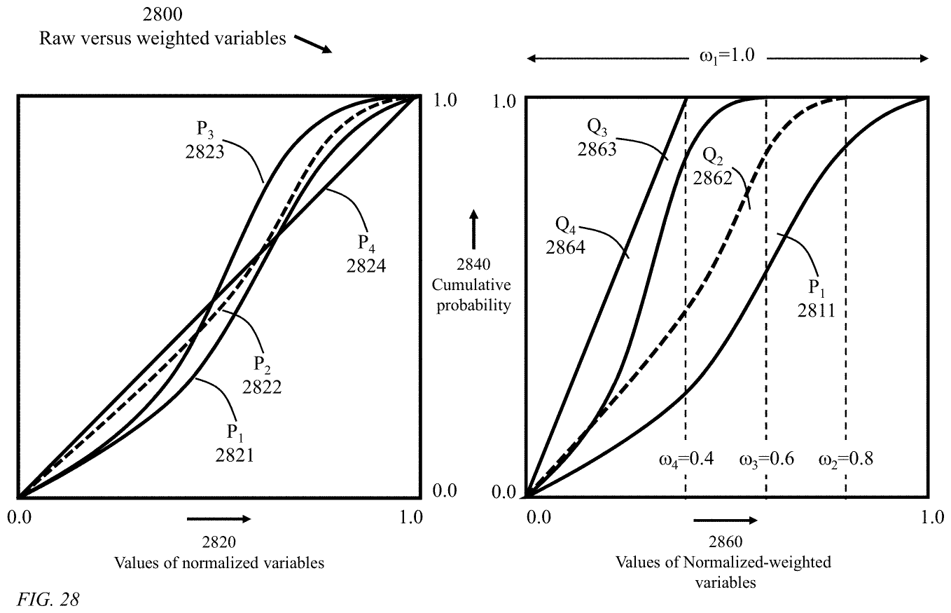

FIG. 28 illustrates a comparison 2800 between cumulative distributions of raw values of four variables (v=4) and cumulative distributions of weighted values of the variables. The raw variables are normalized so that the minimum value of each variable is 0.0 and the maximum value is 1.0 (reference 2820). For the weighted variables, the minimum value of each variable is 0.0 but the maximum value of each variable equals a corresponding variable-specific weight (reference 2860) where the weights applied to the second, third, and fourth variables are 0.8, 0.6, and 0.4, respectively (ω₂=0.8, ω₃=0.6, and ω₂=0.4). The first variable is not weighted (ω₁=0.8). P₁, P₂, P₃, and P₄ (reference numerals 2821, 2822, 2823, and 2824) denote cumulative-probability functions of the normalized variables 2820 corresponding to the first, second, third, and fourth raw variables, respectively. Q₂, Q₃, and Q₄ (reference numerals 2862, 2863, and 2864) denote cumulative-probability functions of normalized-weighted variables 2860 corresponding to the second, third, and fourth raw variables, respectively.

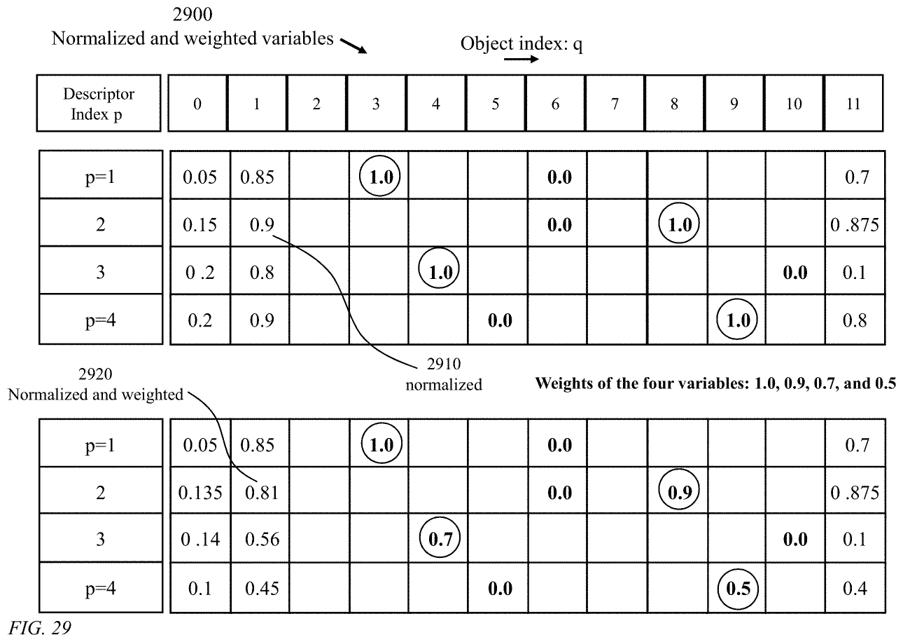

FIG. 29 illustrates a comparison of normalized variables versus normalized and weighted variables where weights are assigned to variables characterizing objects, each weight being variable specific and bounded to positive values not exceeding 1.0. Weighting factors of 0.9, 0.7, and 0.5 are applied to the second, third, and fourth variables, respectively. The first variable is not weighted. For the object of index 0, the values 2910 of the raw normalized variables are 0.05, 0.15, 0.2, and 0.2 while the values 2920 of the normalized weighted variables are 0.05, 0.135, 0.14, and 0.1. For the object of index 1, the values 2910 of the raw normalized variables are 0.85, 0.9, 0.8, and 0.9 while the values 2920 of the normalized weighted variables are 0.85, 0.81, 0.56, and 0.45. Values of raw normalized values and normalized weighted values corresponding to respective upper bounds are circled in FIG. 29.

FIG. 30 illustrates a process 3000 of randomly sampling cumulative distribution functions 3021, 3022, 3023, and 3024 of four variables (v=4) to generate object descriptor vectors. The four variables are normalized to have a minimum value of 0.0 and a maximum value not exceeding 1.0. The four variables are ranked according to perceived level of significance so that the first variable is normalized to values between 0.0 and ω₁, with ω₁=1.0, the second variable is normalized to values between 0.0 and ω₂, the third variable is normalized to values between 0.0 and ω₃, and the fourth variable is normalized to values between 0.0 and ω₄, where ω₁>ω₂>ω₃>ω₄>0.0.

To generate one descriptor vector 3030, a set 3032 of four random numbers r₁, r₂, r₃, and r₄ are generated, each representing a respective value of a cumulative probability of one of the variables (hence bounded between 0.0 and 1.0). Corresponding values v₁, v₂, v₃, and v₄ of the four variables are then determined to form a descriptor vector {v₁, v₂, v₃, v₄}.

To generate another descriptor vector 3040, a set 3042 of four random numbers r₅, r₆, r₇, and r₈ are generated, each representing a respective value of a cumulative probability of one of the variables. Corresponding values u₁, u₂, u₃, and u₄ of the four variables are then determined to form another descriptor vector {u₁, u₂, u₃, u₄}.

Thus, the invention provides yet another method (FIGS. 1-12, 25-30) of generating a set of centroids of a plurality of objects. The method comprises processes of specifying a target number of centroids and employing a processor to execute instructions for: obtaining, for each object of the plurality of objects, a respective characterizing vector of v variables, v>1; determining for each variable of the v variables respective moments based on obtained characterizing vectors; repeating a procedure of generating a centroid until the target number of centroids is attained, and storing the set of centroids for starting a segmentation process of the plurality of objects.

The procedure for generating a centroid comprises processes of generating v random cumulative-probability values and for each variable, accessing a respective software module providing a deduced value of the variable corresponding to a respective one of the random cumulative-probability values, the deduced value being an element of a vector representing a new centroid of the set of centroids, the respective software module being configured to evaluate a respective probability distribution function tailored to the respective moments.

The process of obtaining, for each object of the plurality of objects, a respective characterizing vector of v variable further comprises processes of: assigning v weights to the v variables, each weight being variable specific and bounded to positive values not exceeding 1.0; and normalizing each of the v variables so that: a minimum value of each variable equals 0.0; and a maximum value of each variable equals a corresponding variable-specific weight.

The method further comprises selecting the respective probability distribution function as one of: a Gamma distribution; a Weibull distribution; and a piecewise linear distribution. The respective moments comprise at least a first moment and a second moment. The type of the respective probability distribution function may be user defined.

The processes illustrated in FIGS. 3-6, 10, 11, 13, 16-20, 22, 25, 26, and 29, as applied to a social graph of a vast population, are computationally intensive requiring the use of at least one hardware processor. A variety of processors, such as microprocessors, digital signal processors, and gate arrays, may be employed. Usually processor-readable media are needed and may include floppy disks, hard disks, optical disks, Flash ROMS, non-volatile ROM, and RAM.

Systems of the embodiments of the invention may be implemented as any of a variety of suitable circuitry, such as one or more microprocessors, digital signal processors (DSPs), application-specific integrated circuits (ASICs), field programmable gate arrays (FPGAs), discrete logic, software, hardware, firmware or any combinations thereof. When modules of the systems of the embodiments of the invention are implemented partially or entirely in software, the modules contain a memory device for storing software instructions in a suitable, non-transitory computer-readable storage medium, and software instructions are executed in hardware using one or more processors to perform the techniques of this disclosure.

Numerous specific details have been set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

It should be noted that data and data output from the systems and methods described herein are not, in any sense, abstract or intangible. Instead, the data is necessarily digitally encoded and stored in a physical data-storage computer-readable medium, such as an electronic memory, mass-storage device, or other physical, tangible, data-storage device and medium. It should also be noted that the currently described data-processing and data-storage methods cannot be carried out manually by a human analyst, because of the complexity and vast numbers of intermediate results generated for processing and analysis of even quite modest amounts of data. Instead, the methods described herein are necessarily carried out by electronic computing systems on electronically or magnetically stored data, with the results of the data processing and data analysis digitally encoded and stored in one or more tangible, physical, data-storage devices and media.

Although specific embodiments of the invention have been described in detail, it should be understood that the described embodiments are intended to be illustrative and not restrictive. Various changes and modifications of the embodiments shown in the drawings and described in the specification may be made within the scope of the following claims without departing from the scope of the invention in its broader aspect.

1-4. (canceled)

5. A method of generating centroids of a plurality of objects comprising:
specifying an affinity threshold and employing a processor to execute instructions for:
acquiring a descriptor vector of v variables, v>1, for each object of said plurality of objects;
initializing a centroid set to include an object of said plurality of objects; and
performing for each object of said plurality of objects processes of:
determining an affinity measure to each centroid of said centroid set based on a descriptor vector of said each object and a descriptor vector of said each centroid;
adding said each object as a centroid to said centroid set subject to ascertaining that said affinity measure to said each centroid is less than said affinity threshold;
thereby creating a set of uniformly spaced centroids for use in automated intelligent-marketing systems.

6. The method of claim 5 wherein said acquiring comprises normalizing said v variables so that a value of each variable is within a predefined range.

7. The method of claim 6 wherein said normalizing comprises scaling said variables so that a mean value of each variable equals 1.0.

8. The method of claim 6 wherein said normalizing comprises shifting and scaling said variables so that a minimum value and a maximum value of each variable equal 0.0 and 1.0 respectively.

9. The method of claim 6 wherein said normalizing comprises shifting and scaling said variables so that a minimum value of each variable equals 0.0 and a maximum value of each variable equals a respective variable-specific positive upper bound not exceeding 1.0.

10. The method of claim 5 further comprising terminating said performing subject to ascertaining that said set of centroids contains a number of centroids equal to a predefined upper bound.

11. The method of claims 5, further comprising:
generating non-repeating randomly sequenced indices of objects of said plurality of objects; and
selecting objects of said plurality of objects at indices corresponding to said randomly sequenced indices.

12. The method of claim 5, wherein said determining comprises:
computing a radial affinity level and an angular-affinity level between said each object and said each centroid; and
computing said affinity measure as a function of the radial-affinity level and the angular-affinity level.

13. The method of claim 12 wherein said function is a weighted sum of the radial-affinity level and the angular-affinity level.

14. The method of claim 5 wherein:
said affinity threshold comprises a radial-affinity threshold and an angular-affinity threshold;
said determining comprises computing a radial affinity level and an angular-affinity level between said each object and said each centroid; and
said ascertaining comprises verifying that:
said radial-affinity level is less than said radial-affinity threshold; and
said angular-affinity level is less than said angular-affinity threshold.

15. A method of creating centroids of a plurality of objects comprising:
specifying an affinity threshold and employing a processor to execute instructions for:
acquiring, for each object of said plurality of objects, a respective characterizing vector of v variables, v>1;
deducing for each variable a respective cumulative distribution function to produce v cumulative distribution functions;
generating a succession of descriptor vectors each comprising v variables;
initializing a centroid set to include one of said descriptor vectors;
and
performing for each descriptor vector of said succession of descriptor vectors processes of:
determining an affinity measure to each centroid of said centroid set based on said each descriptor vector and a descriptor vector of said each centroid;
assigning said each descriptor vector to said centroid set as a centroid subject to ascertaining that said affinity measure to said each centroid is less than said affinity threshold;
thereby the method creates a set of uniformly spaced centroids for use in automated intelligent-marketing systems.

16. The method of claim 15 wherein said generating comprises randomly indexing an inverse of a cumulative distribution function of each variable of the v variables to determine v variable values forming a descriptor vector of said succession of descriptor vectors.

17. The method of claim 15 wherein said acquiring comprises normalizing each of said v variables to be within a predefined range.

18. The method of claim 15 wherein said acquiring comprises:
assigning for each variable a respective variable-specific weight greater than 0.0 and not exceeding 1.0; and
shifting and scaling each of said variables so that:
a minimum value of each variable equals 0.0; and
a maximum value of each variable equals a corresponding variable-specific weight.

19. (canceled)

20. The method of claim 15 further comprising terminating said performing upon determining that a count of centroids of said set of centroids equals a predefined upper bound.

21. The method of claim 15, wherein said determining comprises:
computing a radial affinity level and an angular-affinity level between said each descriptor vector and said each centroid; and
computing said affinity measure as a function of the radial-affinity level and the angular-affinity level.

22. The method of claim 21 wherein said function is a weighted sum of the radial-affinity level and the angular-affinity level.

23. The method of claim 15 wherein:
said specifying comprises itemizing said affinity threshold as a radial-affinity threshold and an angular-affinity threshold;
said determining comprises computing a radial affinity level and an angular-affinity level between said each descriptor vector and said each centroid; and
said ascertaining comprises verifying that:
said radial-affinity level is less than said radial-affinity threshold; and
said angular-affinity level is less than said angular-affinity threshold.

24-35. (canceled)

36. An apparatus for generating centroids of a plurality of objects comprising:
a memory device storing processor executable instructions causing a processor to:
determine an affinity threshold;
acquire a descriptor vector of v variables, v>1, for each object of said plurality of objects;
initialize a centroid set to include an object of said plurality of objects; and
for each object of said plurality of objects:
determine an affinity measure to each centroid of said centroid set as a function of a descriptor vector of said each object and a descriptor vector of said each centroid;
add said each object as a centroid to said centroid set subject to ascertaining that said affinity measure to said each centroid is less than said affinity threshold;
thereby the apparatus creates a set of uniformly spaced centroids for use in automated intelligent-marketing systems.

37-40. (canceled)

41. The apparatus of claim 36 wherein said processor executable instructions causing to determine an affinity measure further cause said processor to:
compute a radial affinity level and an angular-affinity level between said each object and said each centroid; and
compute said affinity measure as a function of the radial-affinity level and the angular-affinity level.
